(19) United States
(12) Patent Application Publication
(10) Pub. No.: US 2025/0105958 A1
(43) Pub. Date: Mar. 27, 2025

(54) METHOD AND DEVICE FOR MULTI-SIM UE TO MANAGE COLLIDING GAPS IN NEXT GENERATION MOBILE COMMUNICATION SYSTEM

(71) Applicant: Samsung Electronics Co., Ltd., Suwon-si (KR)

(72) Inventor: Sangyeob JUNG, Suwon-si (KR)

(21) Appl. No.: 18/899,734

(22) Filed: Sep. 27, 2024

(30) Foreign Application Priority Data
Sep. 27, 2023 (KR) 10-2023-0130527
Feb. 23, 2024 (KR) 10-2024-0026452

(51) Int. Cl. H04L 5/00; H04W 72/231; H04W 72/563; H04W 88/06

(52) U.S. Cl. CPC H04L 5/0035; H04W 72/231; H04W 72/563; H04W 88/06

(57) ABSTRACT

The disclosure relates to a 5th generation (5G) or 6th generation (6G) communication system for supporting a higher data transmission rate. A user equipment (UE) and a method performed by a terminal (multi-universal subscriber identity module (USIM) UE (MUSIM UE)) supporting a first universal subscriber identity module (USIM) and a second USIM in a wireless communication system is provided. The method includes receiving, from a base station, a radio resource control (RRC) message for configuring the UE to provide a preference for a multi-universal subscriber identity module (MUSIM) gap and a MUSIM gap priority, identifying whether to initiate a transmission of a UE assistance information message for providing first preference information on the MUSIM gap priority or second preference information indicating to keep all colliding MUSIM gaps based on a timer T346h, and, in case that the timer T346h is not running, initiating the transmission of the UE assistance information message for providing the first preference information or the second preference information.

### CROSS-REFERENCE TO RELATED APPLICATION(S)

This application is based on and claims priority under 35 U.S.C. § 119 (a) of a Korean patent application number 10-2023-0130527, filed on Sep. 27, 2023, in the Korean Intellectual Property Office, and of a Korean patent application number 10-2024-0026452, filed on Feb. 23, 2024, in the Korean Intellectual Property Office, the disclosure of each of which is incorporated by reference herein in its entirety.

### BACKGROUND

### 1. Field

The disclosure relates to an operation of a terminal and a base station in a mobile communication system. More particularly, the disclosure relates to a method and device in which multi-subscriber identification module (SIM) terminals manage colliding gaps.

### 2. Description of Related Art

5^{th} generation (5G) mobile communication technologies define broad frequency bands such that high transmission rates and new services are possible, and can be implemented not only in “Sub 6 GHz” bands, such as 3.5 GHZ, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical (PHY) layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, IAB (integrated access and backhaul) for providing a node for network service area expansion by supporting a wireless backhaul link and an access link in an integrated manner, mobility enhancement including conditional handover and dual active protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device in which multi-SIM terminals manage colliding gaps in a next generation wireless communication system based on the above discussion.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, a radio resource control (RRC) message for configuring the UE to provide a preference for a multi-universal subscriber identity module (MUSIM) gap and a MUSIM gap priority, identifying whether to initiate a transmission of a UE assistance information message for providing first preference information on the MUSIM gap priority or second preference information indicating to keep all colliding MUSIM gaps based on a timer T346h, and in case that the timer T346h is not running, initiating the transmission of the UE assistance information message for providing the first preference information or the second preference information.

In accordance with another aspect of the disclosure, a method performed by a base station in a wireless communication system is provided. The method includes transmitting, to a user equipment (UE), a radio resource control (RRC) message for configuring the UE to provide a preference for a multi-universal subscriber identity module (MUSIM) gap and a MUSIM gap priority, receiving, from the UE, a UE assistance information message including at least one first preference information on the MUSIM gap priority or second preference information indicating to keep all colliding MUSIM gaps, wherein the UE assistance information message including the at least one first preference information or second preference information is received in case that a timer T346h is not running.

In accordance with another aspect of the disclosure, a user equipment (UE) in a wireless communication system is provided. The UE includes a transceiver, and a controller coupled with the transceiver and configured to receive, from a base station, a radio resource control (RRC) message for configuring the UE to provide a preference for a multi-universal subscriber identity module (MUSIM) gap and a MUSIM gap priority, identify whether to initiate a transmission of a UE assistance information message for providing first preference information on the MUSIM gap priority or second preference information indicating to keep all colliding MUSIM gaps based on a timer T346h, and, in case that the timer T346h is not running, initiate the transmission of the UE assistance information message for providing the first preference information or the second preference information.

In accordance with another aspect of the disclosure, a base station in a wireless communication system is provided. The base station includes a transceiver, and a controller coupling with the transceiver and configured to transmit, to a user equipment (UE), a radio resource control (RRC) message for configuring the UE to provide a preference for a multi-universal subscriber identity module (MUSIM) gap and a MUSIM gap priority, and receive, from the UE, a UE assistance information message including at least one first preference information on the MUSIM gap priority or second preference information indicating to keep all colliding MUSIM gaps, wherein the UE assistance information message including the at least one first preference information or second preference information is received in case that a timer T346h is not running.

According to an embodiment of the disclosure, it is possible to provide a method and device in which a multi-SIM terminal manages colliding gaps.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a diagram illustrating a structure of a long term evolution (LTE) system according to an embodiment of the disclosure;

FIG. 1B is a block diagram illustrating a wireless protocol structure in a long term evolution (LTE) system according to an embodiment of the disclosure;

FIG. 1C is a diagram illustrating a structure of a next generation mobile communication system according to an embodiment of the disclosure;

FIG. 1D is a block diagram illustrating a wireless protocol structure of a next generation mobile communication system according to an embodiment of the disclosure;

FIG. 1E is a signal flow diagram illustrating a method of transmitting and receiving UE capability information of a user equipment (UE) (multi-USIM UE, MUSIM UE) supporting multiple universal subscriber identity modules (USIMs) according to an embodiment of the disclosure;

FIG. 1F is a signal flow diagram illustrating a method in which a UE (multi-USIM UE, MUSIM UE) supporting multiple USIMs performs an operation related to USIMs according to an embodiment of the disclosure;

FIG. 1G is a signal flow diagram illustrating a method for a UE (multi-USIM UE, MUSIM UE) supporting multiple USIMs to perform an operation related to USIMs according to an embodiment of the disclosure;

FIG. 1H is a signal flow diagram illustrating a method for a UE (multi-USIM UE, MUSIM UE) supporting multiple USIMs to perform an operation related to USIMs according to an embodiment of the disclosure;

FIG. 1I is a signal flow diagram illustrating a method for a UE (multi-USIM UE, MUSIM UE) supporting multiple USIMs to perform an operation related to USIMs according to an embodiment of the disclosure;

FIG. 1J is a flowchart illustrating a method for a UE (multi-USIM UE, MUSIM UE) supporting multiple USIMs to perform an operation related to USIMs according to an embodiment of the disclosure;

FIG. 1K is a flowchart illustrating a method for a UE (multi-USIM UE, MUSIM UE) supporting multiple USIMs to perform an operation related to USIMs according to an embodiment of the disclosure;

FIG. 1L is a block diagram illustrating an internal structure of a UE according to an embodiment of the disclosure;

FIG. 1M is a block diagram illustrating an internal structure of a new radio (NR) base station according to an embodiment of the disclosure; and

FIG. 1N is a signal flow diagram illustrating a method for a UE (multi-USIM UE, MUSIM UE) supporting multiple USIMs to perform an operation related to USIMs according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and construction may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a term identifying an access node used in the description, a term indicating network entities, a term indicating messages, a term indicating an interface between network objects, a term indicating various identification information and the like are exemplified for convenience of description. Accordingly, the disclosure is not limited to the terms described below, and other terms indicating an object having an equivalent technical meaning may be used.

Hereinafter, a base station is a subject performing resource allocation of a terminal, and may be at least one of a gNode B (gNB), an eNode B (eNB), a node B, a base station (BS), a radio access unit, a base station controller, or a node on a network. The terminal may include a user equipment (UE), a mobile station (MS), a cellular phone, a smart phone, a computer, or a multimedia system capable of performing a communication function. In an embodiment of the disclosure, a downlink (DL) is a wireless transmission path of a signal transmitted from a base station to a UE, and an uplink (UL) is a wireless transmission path of a signal transmitted from a UE to a base station. Hereinafter, although an LTE or long-term evolution advanced (LTE-A) system may be described as an example, embodiments of the disclosure may be applied to other communication systems having a similar technical background or channel type. For example, 5G mobile communication technology (5G, new radio (NR)) developed after LTE-A may be included in a system to which an embodiment of the disclosure may be applied, and the following 5G may be a concept including existing LTE, LTE-A and other similar services. Further, the disclosure may be applied to other communication systems through some modifications within a range that does not significantly deviate from the scope of the disclosure by the determination of a person having skilled technical knowledge. In this case, it will be understood that each block of signal flow diagrams and combinations of the signal flow diagrams may be performed by computer program instructions.

Because these computer program instructions may be mounted in a processor of a general purpose computer, special purpose computer, or other programmable data processing equipment, the instructions performed by a processor of a computer or other programmable data processing equipment generate a means that performs functions described in the signal flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the signal flow diagram block(s). Because the computer program instructions may be mounted on a computer or other programmable data processing equipment, a series of operation steps are performed on the computer or other programmable data processing equipment to generate a computer-executed process; thus, instructions for performing the computer or other programmable data processing equipment may provide steps for performing functions described in the signal flow diagram block(s).

Further, each block may represent a portion of a module, a segment, or a code including one or more executable instructions for executing specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function. In this case, the term ‘-unit’ used in this embodiment means software or hardware components, such as field programmable gate array (FPGA) or application specific integrated circuit (ASIC), and ‘-unit’ may perform certain roles. However, ‘-unit’ is not limited to software or hardware. ‘-unit’ may be constituted to reside in an addressable storage medium or may be constituted to reproduce one or more processors. Therefore, as an example, ‘-unit’ includes components, such as software components, object-oriented software components, class components, and task components, processes, functions, properties, procedures, subroutines, segments of program code, drivers, firmware, microcode, circuit, data, databases, data structures, tables, arrays, and variables. Functions provided in the components and ‘-units’ may be combined into a smaller number of components and ‘-units’ or may be further separated into additional components and ‘-units’. Further, components and ‘-units’ may be implemented to reproduce one or more central processing units (CPUs) in a device or secure multimedia card. Further, in an embodiment or the disclosure, the ‘˜ unit’ may include one or more processors.

Hereinafter, for convenience of description, the disclosure uses terms and names defined in the 3rd generation partnership project (3GPP) standards. However, the disclosure is not limited by the above terms and names, and may be equally applied to systems conforming to other standards. In an embodiment of the disclosure, an evolved node B (eNB) may be used interchangeably with a gNB for convenience of description. For example, a base station described as an eNB may represent a gNB.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

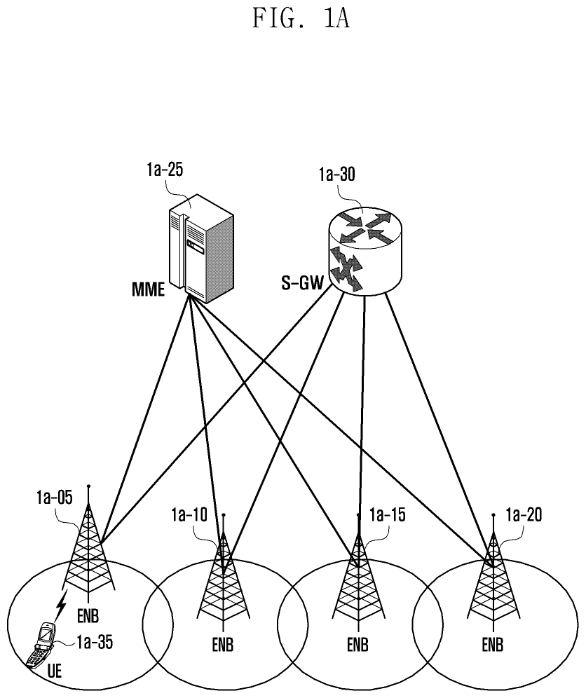

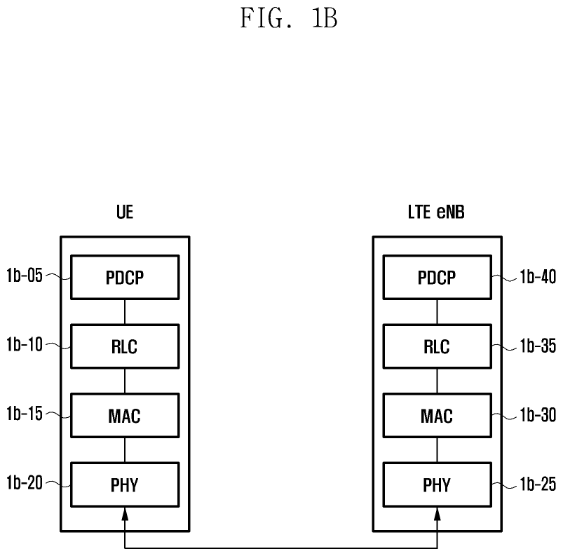

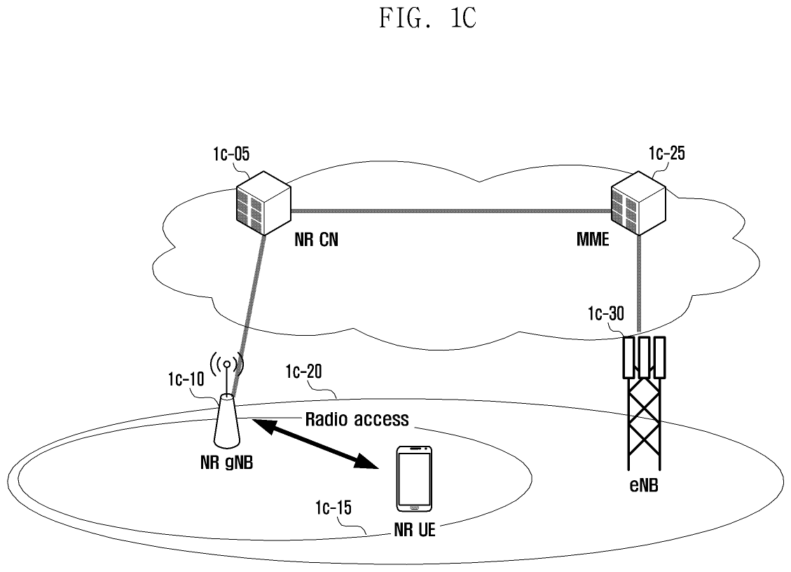

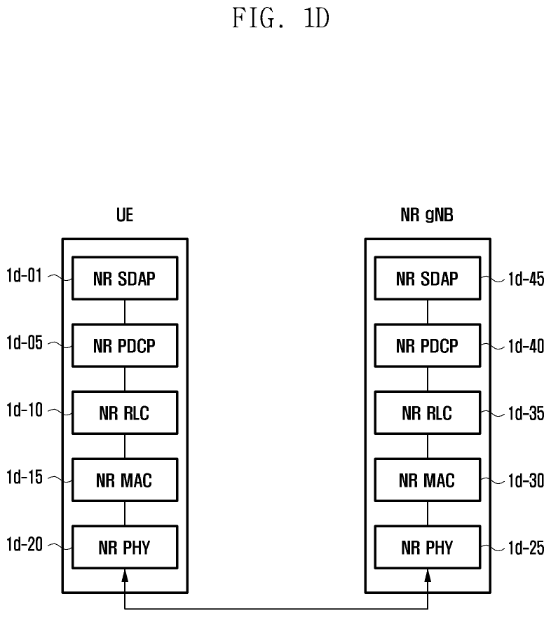

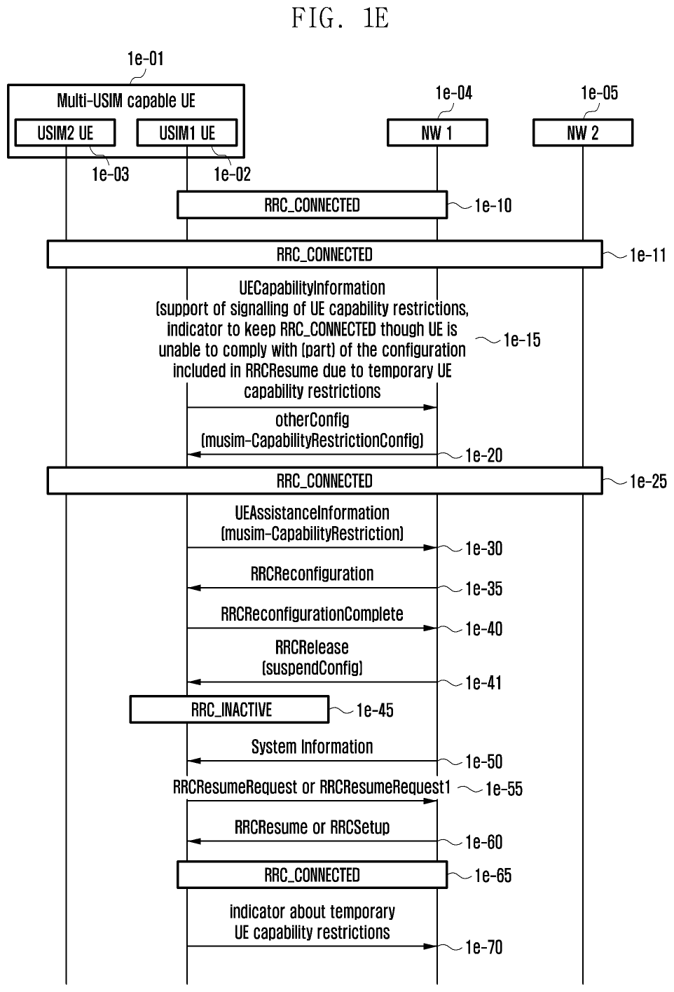

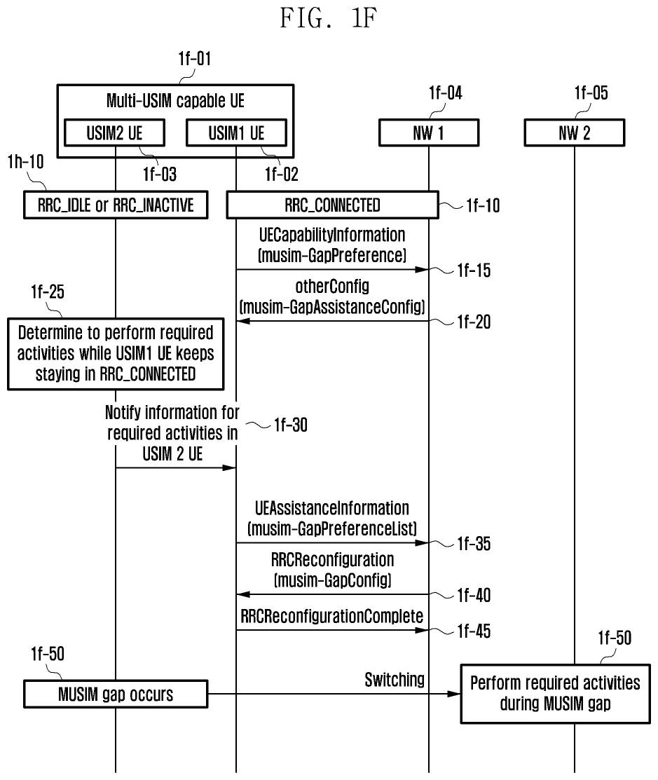

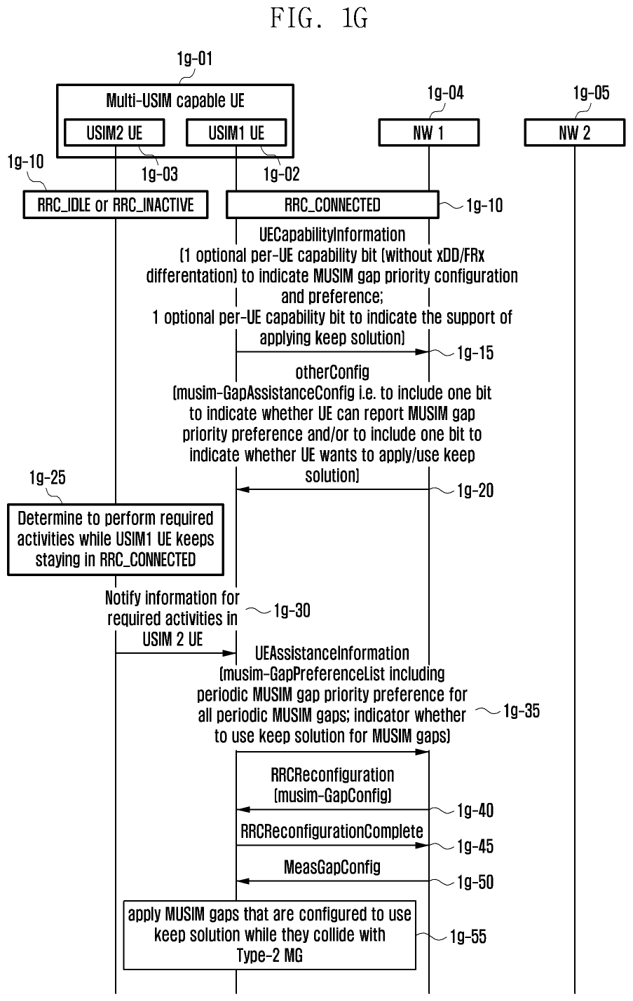

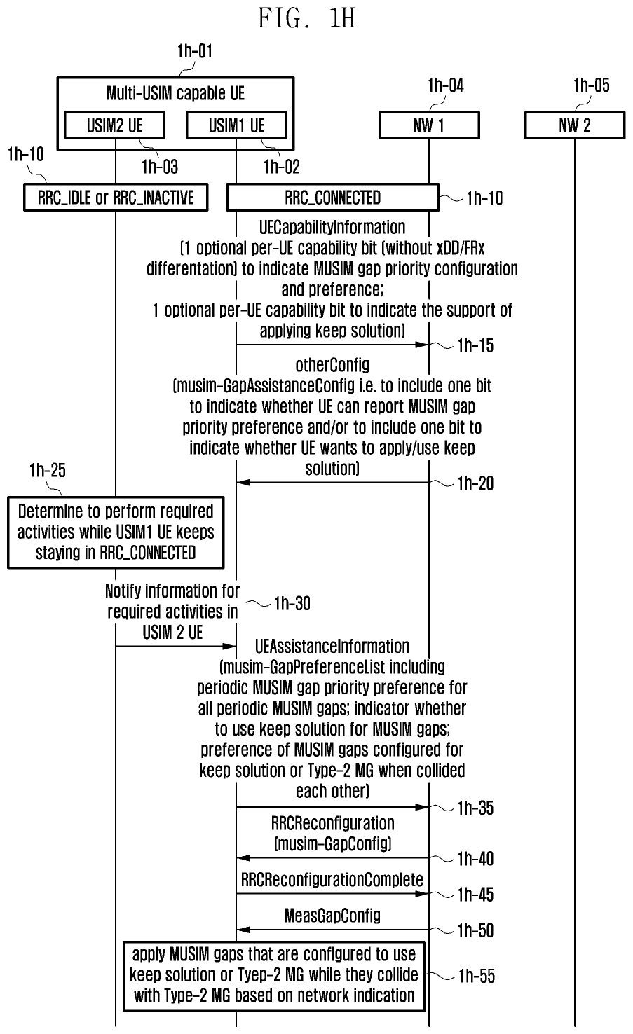

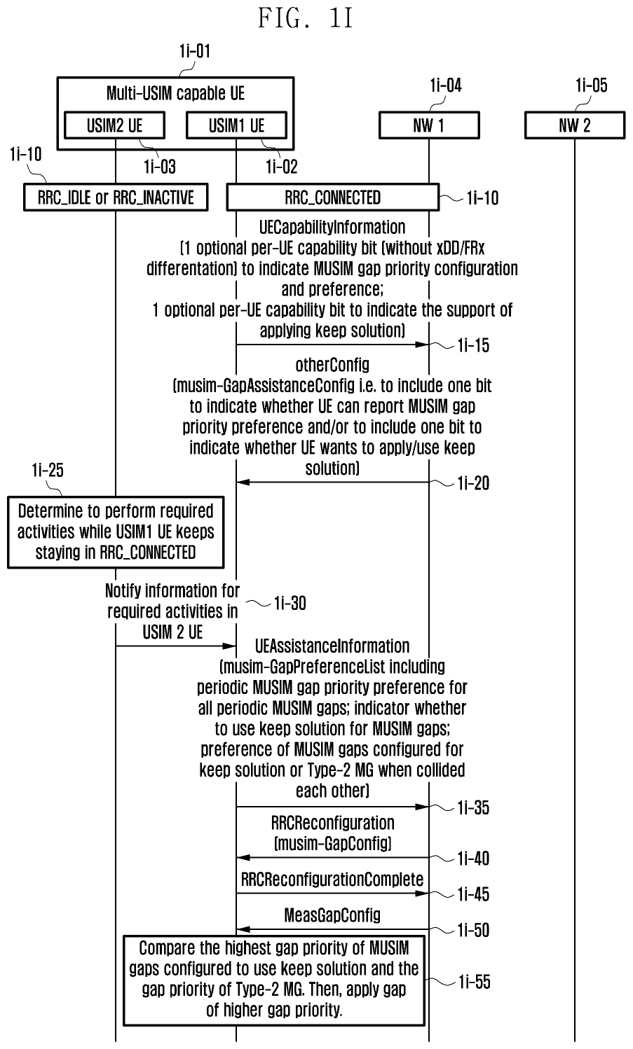

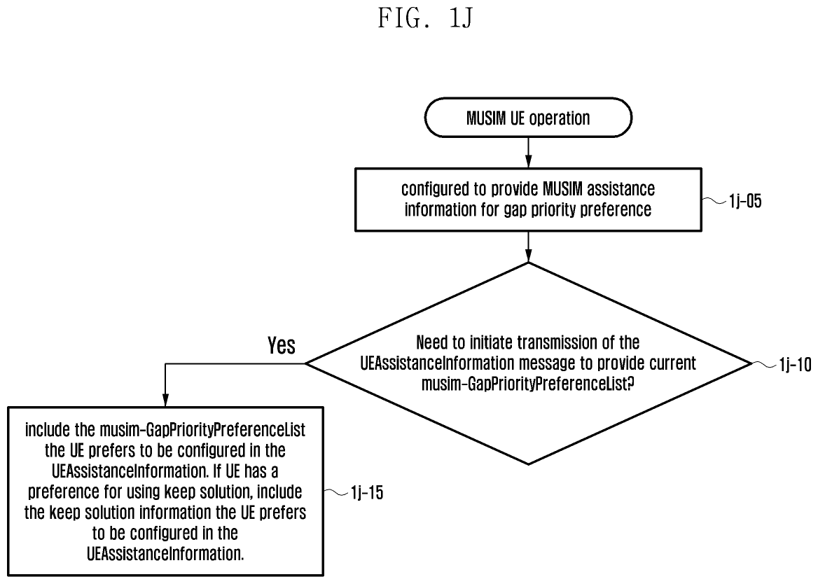

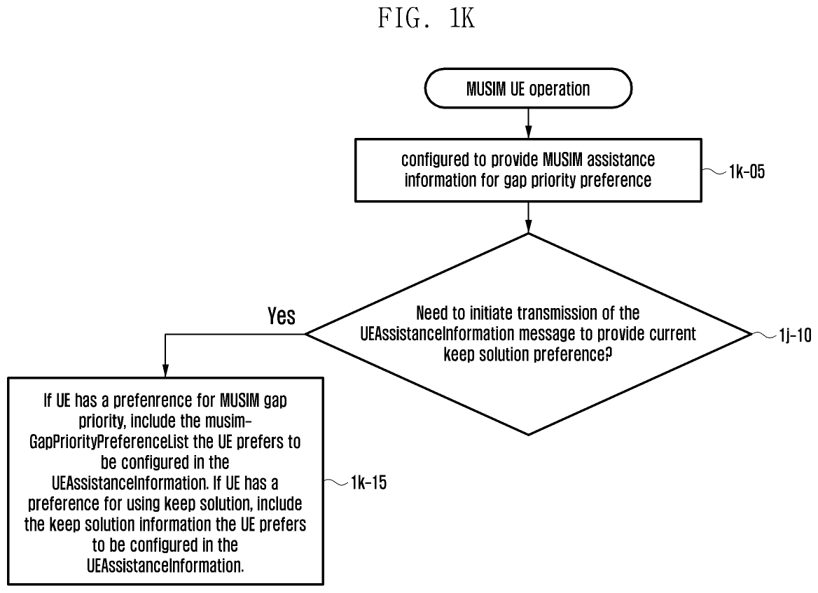

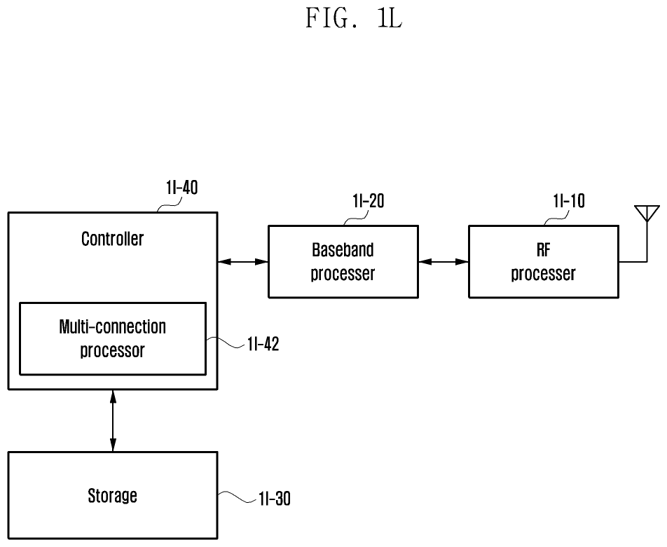

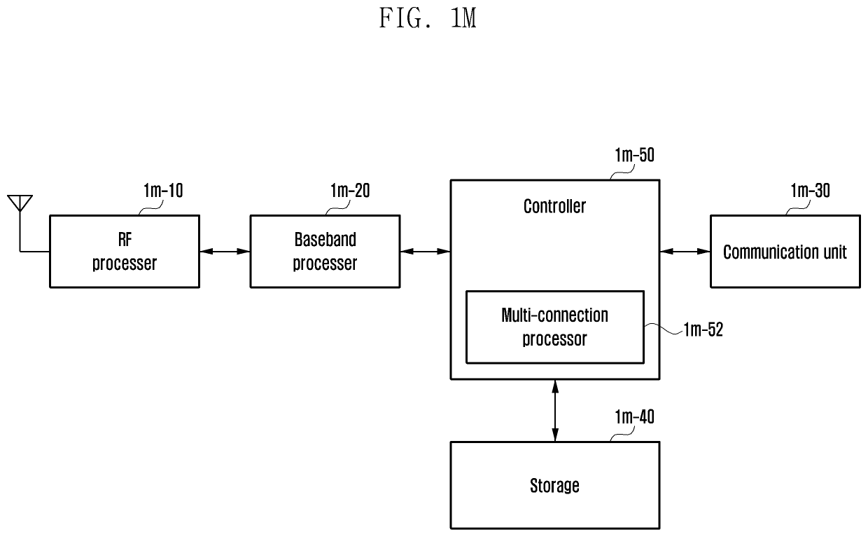

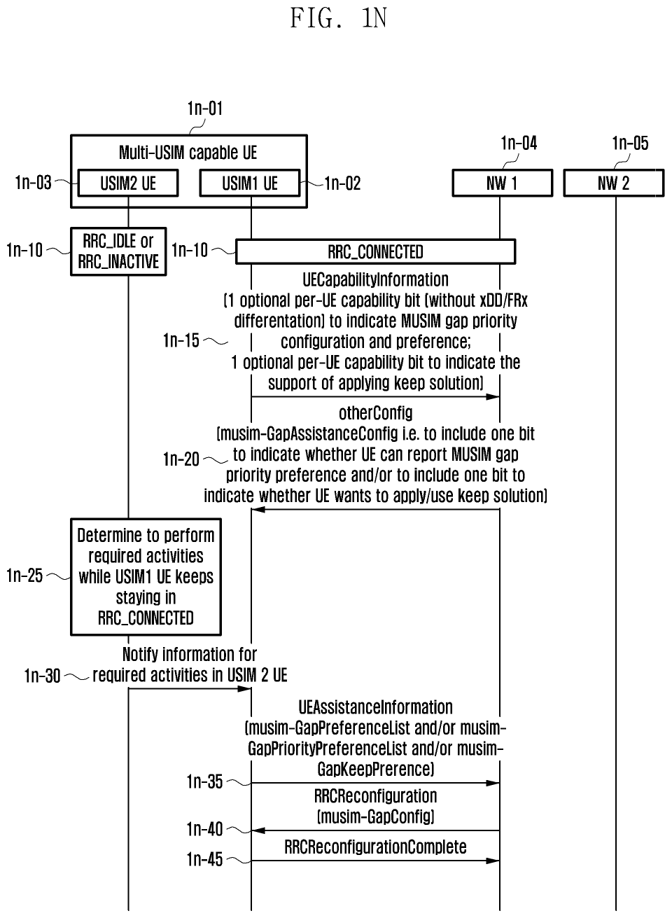

FIG. 1A is a diagram illustrating a structure of a long term evolution (LTE) system according to an embodiment of the disclosure.

Referring to FIG. 1A, as illustrated, a wireless access network of an LTE system includes evolved node Bs (hereinafter, ENBs, node Bs, or base stations) 1a-05, 1a-10, 1a-15, and 1a-20, a mobility management entity (MME) 1a-25, and a serving-gateway (S-GW) 1a-30. A user equipment (hereinafter, UE or terminal) 1a-35 accesses an external network through the ENBs 1a-05 to 1a-20 and the S-GW 1a-30.

Referring to FIG. 1A, the ENBs 1a-05 to 1a-20 correspond to an existing node B of an UMTS system. The ENBs are connected to the UE 1a-35 via a wireless channel and perform a more complex role than that of the existing node B. In the LTE system, because all user traffic including a real-time service, such as a voice over internet protocol (VOIP) via an Internet protocol is serviced through a shared channel, a device that collects and schedules status information, such as a buffer status, an available transmission power status, and a channel status of UEs is required, and the ENBs 1a-05 to 1a-20 are responsible for this. One ENB typically controls multiple cells. For example, in order to implement a transmission speed of 100 Mbps, the LTE system uses, for example, orthogonal frequency division multiplexing (hereinafter, referred to as OFDM) as a wireless access technology in a 20 MHz bandwidth. Further, the LTE system applies an adaptive modulation and coding (hereinafter, referred to as AMC) method that determines a modulation scheme and a channel coding rate according to a channel status of the UE. The S-GW 1a-30 is a device that provides a data bearer and creates or removes a data bearer according to the control of the MME 1a-25. The MME is a device responsible for various control functions as well as a mobility management function for the UE and is connected to multiple base stations.

FIG. 1B is a block diagram illustrating a wireless protocol structure in a long term evolution (LTE) system according to an embodiment of the disclosure.

Referring to FIG. 1B, radio protocols of the LTE system may include packet data convergence protocols (PDCPs) 1b-05 and 1b-40, radio link controls (RLCs) 1b-10 and 1b-35, and medium access controls (MACs) 1b-15 and 1b-30 in the UE and the ENB, respectively.

The PDCPs 1b-05 and 1b-40 are responsible for operations, such as IP header compression/restoration. Main functions of the PDCP may be summarized as follows.
Header compression and decompression: robust header compression (ROHC) only
Transfer of user data
1n-sequence delivery of upper layer protocol data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink.

The RLCs 1b-10 and 1b-35 may reconstitute the PDCP packet data unit (PDU) into an appropriate size and perform an automatic repeat request (ARQ) operation. Main functions of the RLC may be summarized as follows.
Transfer of upper layer PDUs
Error correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MACs 1b-15 and 1b-30 may be connected to several RLC layer devices constituted in one UE, and perform operations of multiplexing RLC PDUs to MAC PDUs and demultiplexing RLC PDUs from MAC PDUs. Main functions of the MAC may be summarized as follows.
Mapping between logical channels and transport channels
Multiplexing/demultiplexing of MAC SDUs belonging to one or different logical channels into and from transport blocks (TB) delivered to and from the physical layer on transport channels
Scheduling information reporting
Error correction through hybrid automatic repeat request (HARQ)
Priority handling between logical channels of one UE
Priority handling between UEs by means of dynamic scheduling
Multimedia broadcast/multicast service (MBMS) service identification
Transport format selection
Padding

Physical layers 1b-20 and 1b-25 may perform operations of channel-coding and modulating higher layer data, making the higher layer data into OFDM symbols and transmitting the OFDM symbols through a radio channel, or demodulating OFDM symbols received through a radio channel, channel-decoding the OFDM symbols, and delivering the OFDM symbols to a higher layer.

FIG. 1C is a diagram illustrating a structure of a next generation mobile communication system according to an embodiment of the disclosure.

Referring to FIG. 1C, as illustrated, a wireless access network of a next generation mobile communication system (hereinafter, NR or 2g) may include a new radio node B (hereinafter, NR gNB or NR base station) 1c-10 and a new radio core network (NR CN) 1c-05. A new radio user equipment (hereinafter, NR UE or terminal) 1c-15 may access an external network through the NR gNB 1c-10 and the NR CN 1c-05.

Referring to FIG. 1C, the NR gNB 1c-10 may correspond to an evolved Node B (eNB) of the existing LTE system 1c-20. The NR gNB may be connected to the NR UE 1c-15 through a radio channel and provide a superior service to that of the existing Node B. In a next generation mobile communication system, because all user traffic may be serviced through a shared channel, a device for collecting and scheduling status information, such as a buffer status, available transmission power status, and channel status of UEs is required, and the NR gNB 1c-10 may be responsible for this. One NR gNB may typically control multiple cells. In order to implement ultrahigh speed data transmission compared to the current LTE, there may be a bandwidth higher than the existing maximum bandwidth, and beamforming technology may be additionally applied using orthogonal frequency division multiplexing (OFDM) as radio access technology. Further, an adaptive modulation & coding (hereinafter, referred to as AMC) scheme of determining a modulation scheme and a channel coding rate according to a channel status of the UE may be applied. The NR CN 1c-05 may perform functions, such as the mobility support, a bearer configuration, and a quality of service (QoS) configuration. The NR CN is a device in charge of various control functions as well as a mobility management function for the UE, and may be connected to a plurality of base stations. Further, the next generation mobile communication system may be interworked with the existing LTE system, and the NR CN may be connected to an MME 1c-25 through a network interface. The MME may be connected to an eNB 1c-30, which is an existing base station.

FIG. 1D is a block diagram illustrating a wireless protocol structure of a next generation mobile communication system according to an embodiment of the disclosure.

FIG. 1D is a block diagram illustrating a wireless protocol structure of a next generation mobile communication system to which the disclosure may be applied.

Referring to FIG. 1D, radio protocols of the next generation mobile communication system may include NR service data adaptation protocols (SDAPs) 1d-01 and 1d-45, NR PDCPs 1d-05 and 1d-40, NR RLCs 1d-10 and 1d-35, and NR MACs 1d-15 and 1d-30 in the UE and the NR base station, respectively.

Main functions of the NR SDAPs 1d-01 and 1d-45 may include some of the following functions.
Transfer of user plane data
Mapping between a QoS flow and a data radio bearer (DRB) for both DL and UL
Marking QoS flow identifier (ID) in both DL and UL packets
Reflective QoS flow to DRB mapping for the UL SDAP PDUs.

For the SDAP layer device, the UE may receive a configuration on whether to use a header of the SDAP layer device or whether to use a function of the SDAP layer device for each PDCP layer device, each bearer, or each logical channel with a radio resource control (RRC) message, and in the case that the SDAP header is configured, the UE may instruct to update or reconfigure mapping information on uplink and downlink QoS flows and data bearers with non-access stratum (NAS) reflective quality of service (QOS) and access stratum (AS) reflective QOS of the SDAP header. The SDAP header may include QOS flow ID information indicating a QoS. QoS information may be used as a data processing priority and scheduling information for supporting a smooth service.

Main functions of the NR PDCPs 1d-05 and 1d-40 may include some of the following functions.

Header compression and decompression: ROHC only
Transfer of user data
1n-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink.

In the above description, reordering of the NR PDCP device may refer to a function of reordering PDCP PDUs received from a lower layer based on a PDCP sequence number (SN), and include a function of delivering data to a higher layer in the rearranged order, a function of directly delivering data without considering the order, a function of rearranging the order and recording lost PDCP PDUs, a function of reporting a status of lost PDCP PDUs to the transmitting side, and a function of requesting retransmission of lost PDCP PDUs.

Main functions of the NR RLCs 1d-10 and 1d-35 may include some of the following functions.
Transfer of upper layer PDUs
1n-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard function
RLC SDU discard

In the above description, in-sequence delivery of the NR RLC device may mean a function of sequentially delivering RLC SDUs received from a lower layer to a higher layer, and include a function of reassembling and delivering several RLC SDUs in the case that an original RLC SDU is divided into several RLC SDUs and received, a function of rearranging received RLC PDUs based on an RLC sequence number (SN) or a PDCP sequence number (SN), a function of rearranging the order and recording lost RLC PDUs, a function of reporting a status of lost RLC PDUs to the transmitting side, a function of requesting retransmission of lost RLC PDUs, and a function of sequentially delivering only RLC SDUs before the lost RLC SDU to a higher layer in the case that there is a lost RLC SDU, or a function of sequentially delivering all RLC SDUs received before the timer starts to the higher layer, when a predetermined timer has expired even if there is a lost RLC SDU, or a function of sequentially delivering all RLC SDUs received so far to the higher layer, when a predetermined timer has expired even if there is a lost RLC SDU. Further, in the above description, the RLC PDUs may be processed in the order of reception (regardless of order of serial numbers and sequence numbers, in order of arrival) and transferred to the PDCP device regardless of order (out-of sequence delivery), and in the case of a segment, the NR RLC device may receive segments stored in a buffer or to be received later, reconstitute segments into one complete RLC PDU, and then transfer the one complete RLC PDU to the NR PDCP device. The NR RLC layer may not include a concatenation function, and the NR MAC layer may perform the concatenation function or the concatenation function may be replaced with a multiplexing function of the NR MAC layer.

In the above description, out-of-sequence delivery of the NR RLC device may mean a function of directly delivering RLC SDUs received from a lower layer to a higher layer regardless of order and include a function of reassembling and delivering several RLC SDUs in the case that an original RLC SDU is divided into several RLC SDUs and received and a function of storing RLC SNs or PDCP sequence numbers (SNs) of received RLC PDUs, arranging the order, and recording lost RLC PDUs.

The NR MACs 1d-15 and 1d-30 may be connected to several NR RLC layer devices constituted in one UE, and main functions of the NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

NR PHY layers 1d-20 and 1d-25 may perform operations of channel-coding and modulating higher layer data, making the higher layer data into OFDM symbols and transmitting the OFDM symbols through a radio channel, or demodulating OFDM symbols received through a radio channel, channel-decoding the OFDM symbols, and delivering the OFDM symbols to a higher layer.

FIG. 1E is a signal flow diagram illustrating a method of transmitting and receiving UE capability information of a UE (multi-USIM UE, MUSIM UE) supporting multiple universal subscriber identity modules (USIMs) according to an embodiment of the disclosure.

Referring to FIG. 1E, it illustrates a signal flow diagram illustrating a process in which a multi-USIM UE (hereinafter, MUSIM UE) supporting multiple USIMs requests and/or provides temporary UE capability restrictions to a base station.

Referring to FIG. 1E, a multi-USIM capable UE 1e-01 may mean a UE that supports multiple USIMs in one device. In an embodiment of the disclosure, for convenience of description, a dual-USIM UE supporting two USIMs is considered. For example, the multi-USIM capable UE 1e-01 may mean a USIM 1 UE 1e-02 in the case of operating in a USIM 1 and mean a USIM2 UE 1e-03 in the case of operating in a USIM 2.

In this case, base stations 1e-04 and 1e-05 associated with each USIM may recognize a USIM 1 UE 1e-02 and a USIM 2 UE 1e-03 as separate UEs, not the multi-USIM capable UE 1e-01 in which a USIM 1 UE 1e-02 and a USIM 2 UE 1e-03 operate in the same device. The USIM 1 UE 1e-02 and the USIM 2 UE 1e-03 according to an embodiment of the disclosure may share and use a hardware capability of the multi-USIM capable UE 1e-01 with each other. Therefore, in the case that the USIM 1 UE 1e-02 and the USIM 2 UE 1e-03 simultaneously transmit and receive signals to and from a base station 1 (NW1) 1e-04 and a base station 2 (NW2) 1e-05, the capability of each USIM UE may be temporarily limited by each other.

In step 1e-10, the USIM 1 UE 1e-02 may configure a radio resource control (RRC) connection with the NW1 1e-04 to be in an RRC connected mode (RRC_CONNECTED).

In step 1e-11, the USIM 2 UE 1e-03 may configure an RRC connection with the NW2 1e-05 to be in an RRC connected mode (RRC_CONNECTED).

In step 1e-11, the USIM 1 UE 1e-02 may transmit a UE capability information message (UECapabilityInformation) containing capability information of the multi-USIM capable UE 1e-01 to the NW1 1e-04.

The capability of the multi-USIM capable UE 1e-01 is static, but because the USIM 1 UE 1e-02 shares and uses the capability of the multi-USIM capable UE 1e-01 with the USIM 2 UE 1e-03, the capability of the USIM 1 UE 1e-02 may be temporarily restricted according to an operation of the USIM 2 UE 1e-03.

For example, the USIM 1 UE 1e-02 may include a full capability of not sharing hardware with the USIM 2 UE 1e-03 in UECapabilityInformation according to the capability of the multi-USIM capable UE 1e-01, but the capability of the USIM 1 UE 1e-02 may be temporarily restricted according to the operation of the USIM 2 UE 1e-03. Therefore, the USIM 1 UE 1e-02 may include capability information related to such temporary UE capability restriction in the message and notify the NW1 1e-04 of the capability information. Specifically, the message may include the following information.
Capability in which the USIM 1 UE 1e-02 may request or provide details of temporary UE capability restrictions to the NW1 1e-04 through a predetermined RRC message (e.g., UEAssistanceInformation).
In the case that the capability of the USIM 1 UE 1e-02 is temporarily restricted by the USIM 2 UE 1e-03, a capability in which the USIM 1 UE 1e-02 may transmit a predetermined RRC message including specific temporary UE capability restriction information therefor to the NW1 1e-04 according to a configuration of the NW1 1e-04.
Capability in which the USIM 1 UE 1e-02 may proactively notify the NW1 1e-04 of temporary UE capability restrictions through a predetermined RRC message (e.g., RRCSetupComplete, RRCResumeComplete, RRCReconfigurationComplete, RRCReestablishmentComplete).
In the case that the capability of the USIM 1 UE 1e-02 is temporarily restricted by the USIM 2 UE 1e-03, a capability in which the USIM 1 UE 1e-02 may transmit a predetermined RRC message including an indicator indicating whether there are temporary capability restrictions therefor to the NW1 1e-04 according to a configuration of the NW1 1e-04.
When the USIM 1 UE 1e-02 receives an RRC connection resume message (RRCResume) from the NW1 1e-04 during an RRC connection resume procedure in an RRC inactive mode (RRC_INACTIVE), an indicator or information element indicating a capability not to perform “inability to comply with RRCResume” while maintaining the RRC connected mode (RRC_CONNECTED) even in the case that some of configuration information stored in the RRC connection resume message may not be temporarily applied or followed due to the USIM 2 UE 1e-03.
When the inability to comply with RRCResume is performed, the UE performs an operation of changing the mode thereof to an RRC idle mode (RRC_IDLE) through an ‘RRC resume failure’ release reason value, and a specific procedure thereof may be as illustrated in Table 1.

TABLE 1
5.3.13.11 Inability to comply with RRCResume
The UE shall:

| 1> | if the UE is unable to comply with (part of) the configuration | |
|---|---|---|
| | included in the RRCResume message; | |
| | 2> | perform the actions upon going to RRC_IDLE as specified |

| | |
|---|---|
| | in 5.3.11 with release cause ’RRC Resume failure’, |
| NOTE 1: | The UE may apply above failure handling also in case |
| | the RRCResume message causes a protocol error for |
| | which the generic error handling as defined in 10 |
| | specifies that the UE shall ignore the message. |
| NOTE 2: | If the UE is unable to comply with part of the |
| | configuration, it does not apply any part of the |
| | configuration, i.e. there is no partial success/failure. |

For example, the USIM 1 UE 1e-02 determines inability to comply with RRCResume based on the actual UE capability (i.e., UECapabilityInformation), and in the case that there are temporary UE capability restrictions due to the USIM 2 UE 1e-03, the USIM 1 UE 1e-02 does not change the mode thereof to RRC_IDLE, but maintains RRC_CONNECTED and later notifies the NW1 1e-04 of specific temporary UE capability restriction information (e.g., transmits a UEAssistanceInformation message); thus, the NW1 1e-04 may reconstitute configuration information (e.g., transmit a RRCReconfiguration message) according to temporary UE capability restriction information.
When the USIM 1 UE 1e-02 receives an RRC connection resumption message (RRCResume) from the NW1 1e-04 during the RRC connection resume procedure in the RRC inactive mode (RRC_INACTIVE), an indicator indicating a change to RRC_IDLE in the case that some of configuration information stored in the RRC connection resumption message may not be temporarily applied or followed due to the USIM 2 UE 1e-03 or an indicator indicating that only basic configuration information (e.g., configuration information included in RRCSetup) may be applied to the RRC connection resumption message.

In step 1e-20, the NW1 1e-04 may transmit otherConfig including a musim-CapabilityRestrictionConfig to the USIM1 UE 1e-02.

The NW1 1e-04 may transmit a predetermined RRC message (e.g., RRCReconfiguration message) including configuration information (musim-CapabilityRestrictionConfig) that allows the USIM1 UE 1e-02 to report preferred/required temporary UE capability restriction information to the NW1 1e-04. The musim-CapabilityRestrictionConfig may be stored in otherConfig. For example, the musim-CapabilityRestrictionConfig may include the following information.
Maximum multiple input and multiple output (hereinafter, MIMO) layer restriction request/change configuration information
A new prohibit timer value or an indicator indicating whether the USIM 1 UE 1e-02 may transmit preferred maximum MIMO layer restriction information to the NW1 1e-04 due to a MUSIM operation (e.g., the USIM 2 UE 1e-03 performs data transmission and reception to and from the NW2 1e-05 after changing to the RRC connected mode or performs required operations after changing from the RRC connected mode to the RRC idle mode or the RRC inactive mode).
Measurement gap requirement restriction request/change configuration information
A new prohibit timer value or an indicator indicating whether the USIM 1 UE 1e-02 may transmit preferred measurement gap requirement restriction information to the NW1 1e-04 due to a MUSIM operation.
Serving cell or serving cell group release/configuration restriction request configuration information
A new prohibit timer value or an indicator indicating whether the USIM 1 UE 1e-02 may transmit currently configured serving cell (or serving cell group) release request information to the NW1 1e-04 due to a MUSIM operation.
Alternatively, a new prohibit timer value or an indicator indicating whether the USIM 1 UE 1e-02 may transmit information indicating not to configure additional configurable cells or frequencies to the NW1 1e-04 due to a MUSIM operation.
Maximum supportable bandwidth or band combination restriction request/change configuration information
A new prohibit timer value or an indicator indicating whether the USIM 1 UE 1e-02 may transmit preferred maximum supportable bandwidth or band combination restriction information to the NW1 1e-04 due to a MUSIM operation.
An indicator indicating whether the USIM 1 UE 1e-02 may proactively notify the NW1 1e-04 of temporary UE capability restrictions through a predetermined RRC message transmitting to the NW1 1e-04 after changing the mode thereof to an RRC connected mode or a predetermined RRC message transmitting in an RRC connected mode.

In step 1e-25, the USIM 2 UE 1e-03 may configure an RRC connection with the NW2 1e-05 to be in an RRC connected mode (RRC_CONNECTED).

In step 1e-30, the USIM 1 UE 1e-02 may transmit UEAssistanceInformation including musim-CapabilityRestriction to the NW1 1e-04.

More specifically, the USIM 1 UE 1e-02 may transmit a predetermined RRC message (e.g., UEAssistanceInformation) including temporary UE capability restriction information (musim-CapabilityRestriction) due to the operation of the USIM 2 UE 1e-03 to the NW1 1e-04. For example, the predetermined RRC message may include at least one of the following temporary UE capability restriction information.
Restriction information on the number of MIMO layers for serving cells for each frequency range (FR)
Separate MIMO layer number restriction information may be included for each uplink or downlink.
Restriction information on measurement gap
Explicit release request information for a serving cell or serving cell group.
Supportable bandwidth or bandwidth combination information
The above information may be represented per cell, per frequency, or per carrier.

For reference, in step 1e-30, in the case that at least one of the following conditions is satisfied, the USIM 1 UE 1e-02 may transmit a predetermined RRC message (e.g., UEAssistanceInformation) including temporary UE capability restriction information (musim-CapabilityRestriction) to the NW1 1e-04.
Condition 1: In the case that the predetermined RRC message (e.g., UEAssistanceInformation) including temporary UE capability restriction information (musim-CapabilityRestriction) has not been transmitted to the NW1 1e-04 after a musim-CapabilityRestrictionConfig was configured by the NW1 1e-04.
Condition 2: In the case that current temporary UE capability restriction information is different from temporary UE capability restriction information (musim-CapabilityRestriction) most recently transmitted to the NW1 1e-04
Condition 3: In the case that current temporary UE capability restriction information is different from temporary UE capability restriction information (musim-CapabilityRestriction) most recently transmitted to the NW1 1e-04 and that the prohibit timer is not running.
Even if specific temporary UE capability restriction information is changed, condition 3 is satisfied, and the UE has a feature of running only one prohibit timer.
Condition 4: In the case that current temporary UE capability restriction information is different from temporary UE capability restriction information (musim-CapabilityRestriction) most recently transmitted to the NW1 1e-04 and that the prohibit timer corresponding to the capability restriction information is not running.
The difference from condition 3 is that the USIM 1 UE 1e-02 may separately run a prohibit timer for each temporary UE capability restriction feature to determine condition 4. Each temporary UE capability restriction feature means each information, such as MIMO layer number restriction information and measurement gap restriction information.

In step 1e-35, the NW1 1e-04 may transmit an RRCReconfiguration message to the USIM 1 UE 1e-02.

More specifically, the NW1 1e-04 may transmit a predetermined RRC message (e.g., RRCReconfiguration) containing RRC configuration information based on temporary UE capability restriction information provided by the USIM 1 UE 1e-02 in response to step 1e-30.

In step 1e-40, the USIM 1 UE 1e-02 may transmit an RRCReconfigurationComplete message to the NW1 1e-04.

More specifically, the USIM 1 UE 1e-02 may transmit a predetermined RRC message (e.g., RRCReconfigurationComplete) to the NW1 1e-04 in response to a predetermined RRC message received in step 1e-35.

In step 1e-41, the NW1 1e-04 may transmit an RRC connection release message (RRCRelease) including suspension configuration information (suspendConfig) to the USIM 1 UE 1e-02.

In step 1e-45, the USIM 1 UE 1e-02 may change the mode thereof to an RRC inactive mode (RRC_INACTIVE).

In step 1e-50, the USIM 1 UE 1e-02 may acquire system information from the NW1 1e-04.

In system information according to an embodiment of the disclosure, in the case that the USIM 1 UE 1e-02 has temporary UE capability restrictions due to a MUSIM operation (i.e., by the USIM 2 UE 1e-03), an indicator indicating whether it is allowed to transmit an indicator indicating this to the NW1 1e-04 may be broadcasted.

For example, in the case that system information includes the indicator, the USIM 1 UE 1e-02 may include an indicator about temporary UE capability restrictions in a predetermined RRC message (e.g., RRCSetupComplete, RRCResumeComplete, RRCReconfigurationComplete, RRCReestablishmentComplete) and transmit the predetermined RRC message to the NW1 1e-04.

The NW1 1e-04 that has received the temporary UE capability restriction indicator may not provide RRC configuration information to the USIM 1 UE 1e-02 according to the capability of the multi-USIM capable UE 1e-01, but may provide RRC configuration information according to specific temporary UE capability restriction information after receiving the specific temporary UE capability restriction information later from the USIM 1 UE 1e-02.

In step 1e-55, the USIM 1 UE 1e-02 may transmit an RRC connection resumption request message (e.g., RRCResumeRequest or RRCResumeRequest1) so as to resume an RRC connection with the NW1 1e-04.

In step 1e-60, the NW1 1e-04 may transmit an RRC connection resumption message (RRCResume) or an RRC connection setup message (RRCSetup) to the USIM 1 UE 1e-02.

### More Specifically,

Based on information received in step 1e-15, in the case that the USIM 1 UE 1e-02 may change the mode thereof to the RRC connected mode upon receiving the RRC connection resumption message even though the USIM 1 UE 1e-02 may not temporarily apply or follow (some) configuration information (e.g., Carrier Aggregation or dual connectivity related configuration) included in the RRC connection resumption message due to the operation of the USIM 2 UE 1e-03, the base station may transmit the RRC connection resumption message to the USIM 1 UE 1e-02.
Based on information received in step 1e-15, in the case that the USIM 1 UE 1e-02 temporarily fails to apply or follow (some) configuration information (e.g., Carrier Aggregation or dual connectivity related configuration) included in the RRC connection resumption message due to the operation of the USIM 2 UE 1e-03 and changes the mode thereof to an RRC idle mode upon receiving the RRC connection resumption message, the base station may transmit an RRC connection setup message to the USIM 1 UE 1e-02 or may transmit an RRC connection resumption message that configures only (some) information included in the RRC connection setup message.

For example, the RRC connection resumption message may include a fullConfig, and include (some) information (e.g., masterCellGroup, radioBearerConfig) included in the RRC connection setup message.

In step 1e-65, the USIM 1 UE 1e-02 may apply configuration information received in step 1e-60 to change the mode thereof to an RRC connected mode (RRC_CONNECTED).

In step 1e-60, the USIM 1 UE 1e-02 in an RRC connected mode may transmit a predetermined RRC message (RRCResumeComplete or RRCSetupComplete) including an indicator about temporary UE capability restrictions to the NW1 1e-04.

A predetermined RRC message may mean at least one of the following:
The USIM 1 UE 1e-02 transmits an RRCSetupComplete or RRCResumeComplete message including the indicator to the NW1 1e-04 through an RRC connection resume procedure.

For reference, in the case that at least one of the following conditions is satisfied, the USIM 1 UE 1e-02 may transmit a predetermined RRC message including an indicator about temporary UE capability restrictions to the NW1 1e-04.
Condition: In the case that an indicator indicating whether the USIM1 UE 1e-02 may transmit to the NW1 1e-04 whether there are temporary UE capability restrictions is broadcasted in the system information (step 1e-50) and that the USIM 1 UE 1e-02 has temporary UE capability restrictions by the USIM 2 UE 1e-03 (or in the case that the USIM 1 UE 1e-02 wants to perform the above-described step 1e-30).

FIG. 1F is a signal flow diagram illustrating a method in which a UE (multi-USIM UE, MUSIM UE) supporting multiple USIMs performs an operation related to USIMs according to an embodiment of the disclosure.

Referring to FIG. 1F, it illustrates a signal flow diagram illustrating a process in which a multi-USIM UE (hereinafter, MUSIM UE) supporting multiple USIMs performs an operation associated with other USIMs while maintaining an RRC connected mode (RRC_CONNECTED) with a base station associated with one USIM.

A multi-USIM capable UE 1f-01 according to an embodiment of the disclosure may mean a UE supporting two or more USIMs. According to an embodiment of the disclosure, for convenience of description, a dual-USIM UE supporting two USIMs is considered. The dual-USIM UE has a feature of transmitting to a base station associated with one USIM at a given time or transmitting to a base station associated with each USIM. Similarly, a dual-USIM UE has a feature of receiving from a base station associated with one USIM at a given time or simultaneously receiving from a base station associated with each USIM.

Referring to FIG. 1F, the multi-USIM capable UE 1f-01 may mean a UE that supports multiple USIMs in one device. For example, the MUSIM UE may mean a USIM 1 UE 1f-02 in the case of operating in a USIM 1, and mean a USIM 2 UE 1f-03 in the case of operating in a USIM 2. The base station associated with each USIM may not recognize the MUSIM UE as one UE, but may recognize the MUSIM UE as one UE for each USIM UE. For example, the NW1 1f-04 may recognize the USIM 1 UE 1f-02 as one UE, and the NW2 1f-05 may recognize the USIM 2 UE 1f-03 as one UE.

Hereinafter, in embodiments of the disclosure, for convenience of description, in the case that the MUSIM UE communicates using the USIM 1, the MUSIM UE is referred to as a USIM 1 UE, and in the case that the MUSIM UE communicates using the USIM 2, the MUSIM UE is referred to as a USIM 2 UE. For example, the MUSIM UE may be a USIM 1 UE or a USIM 2 UE according to which USIM between the USIM 1 and USIM 2 is used.

In step 1f-10, the USIM 1 UE 1f-02 may configure an RRC connection with the NW1 1f-04 to be in an RRC connected mode (RRC_CONNECTED).

In step 1f-10, the USIM 2 UE 1f-03 may not configure an RRC connection with the NW2 1f-05 to be in an RRC idle mode (RRC_IDLE) or an RRC inactive mode (RRC_INACTIVE).

The disclosure may be equally applied even to the case that the USIM 2 UE 1f-03 may configure an RRC connection with the NW2 1f-05 to be in an RRC connected mode (RRC_CONNECTED).

In step 1f-15, the USIM 1 UE 1f-02 may transmit UECapabilityInformation including musim-CapPreference to the NW1 1f-04.

More specifically, the USIM 1 UE 1f-02 may transmit a UE capability information message (UECapabilityInformation) to the NW1 1f-04. The UE capability information message may include the following information.
Indicator (musim-GapPreference) indicating that the USIM 1 UE 1f-02 may transmit a MUSIM gap preference and related MUSIM gap configuration as MUSIM assistance information to the NW1 1f-04. The UE supporting the above capability may support three periodic gaps and one aperiodic gap.

In step 1f-20, the NW1 1f-04 may transmit otherConfig including musim-GapAssistanceConfig to the USIM1 UE 1f-02.

More specifically, the NW1 1f-04 may transmit a predetermined RRC message (e.g., RRCReconfiguration message) including configuration information (musim-GapAssistanceConfig) that enables the USIM1 UE 1f-02 to report preferred/required MUSIM gap information for a MUSIM operation.

Additionally, the musim-GapAssistanceConfig may be stored in otherConfig. The musim-GapAssistanceConfig may include one or more of the following information.
musim-GapProhibitTimer value
In the case that the NW1 1f-04 configures or sets up the new prohibit timer value to the USIM 1 UE 1f-02, when the USIM 1 UE 1f-02 initiates a procedure for sending preferred MUSIM gap configuration information to the NW1 1f-04, the USIM 1 UE 1f-02 may run a new timer with the new prohibit timer value and transmit a predetermined RRC message (e.g., UEAssistanceInformation) including the preferred MUSIM gap configuration information to the NW1 1f-04. In the case that the new timer is running, the USIM 1 UE 1f-02 may not transmit a predetermined RRC message including preferred MUSIM gap configuration information to the NW1 1f-04. For example, in the case that the new timer is not running or expires, the USIM 1 UE 1f-02 may transmit a predetermined RRC message (e.g., UEAssistanceInformation) including preferred MUSIM gap configuration information to the NW1 1f-04.

In step 1f-25, the USIM 2 UE 1f-03 may determine whether to perform required activities in an RRC idle mode or an RRC inactive mode.

The predetermined operation is an operation of the USIM 2 UE 1f-03 related to the NW2 1f-05, and may mean at least one of the following.
Operation 1: The USIM 2 UE 1f-03 does not perform an RRC connection establishment procedure or an RRC connection resume procedure with the NW2 1f-05, but performs an operation of receiving a signal transmitted by the NW2 1f-05 or an internal operation of the USIM 2 UE through reception. For example,
The USIM 2 UE 1f-03 may monitor a paging channel or a short message related to the NW2 1f-05. For example, the USIM2 UE 1f-03 may monitor a paging occasion every discontinuous reception (DRX) cycle.
The USIM 2 UE 1f-03 may monitor to receive a notification of a change in system information related to the NW2 1f-05. For example, the USIM2 UE 1f-03 may monitor a paging occasion every discontinuous reception (DRX) cycle.
The USIM 2 UE 1f-03 may perform a cell selection or cell reselection evaluation procedure. For example, USIM 2 UE 1f-03 may perform serving cell or peripheral cell measurement as part of a cell selection or cell reselection evaluation procedure.
Procedure in which the USIM 2 UE 1f-03 selects a public land mobile network (PLMN)
Operation 2: Operation in which the USIM 2 UE 1f-03 does not perform an RRC connection establishment procedure or an RRC connection resume procedure with the NW2 1f-05, but performs data transmission and reception to and from the NW2 1f-05. For example,
The USIM 2 UE 1f-03 requests on-demand system information for acquiring system information to the NW2 1f-05 or in an on-demand manner.
Operation 3: Operation in which the USIM 2 UE 1f-03 in an RRC inactive mode performs an RRC connection resume procedure with the NW2 1f-05, but fails to change to an RRC connected mode. For example,
The USIM 2 UE 1f-03 receives RAN paging transmitted by the NW2 1f-05, and the received RAN paging includes a UE identifier (I-RNTI) that indicates the USIM 2 UE 1f-03, but the USIM 1 UE 1f-02 may should continue to transmit and receive data to and from the NW1 1f-04. In this case, the USIM 2 UE 1f-03 may transmit an RRCResumeRequest/1 message containing a busy indication indicating that it may not respond to the RAN paging received from the NW2 1f-05 to the NW2 1f-05. For reference, the busy indication may be stored in the resumeCause. The NW2 1f-05 may transmit an RRCReject or RRCRelease message to the USIM 2 UE 1f-03 in response thereto.
Operation 4: Operation in which the USIM 2 UE 1f-03 may perform an RRC connection establishment or resume procedure with the NW2 1f-05 to transition the mode thereof to the RRC connected mode. For example,
Registration update procedure or RAN notification area update procedure of the USIM 2 UE 1f-03

The above-described operation may be a periodic operation, an aperiodic operation, or a one-time operation.

In step 1f-30, the USIM 2 UE 1f-03 may notify the USIM 1 UE 1f-02 of information required to perform the above-described operations in step 1f-25 in an RRC idle mode or an RRC inactive mode.

For reference, step 1f-30 may be implemented by the MUSIM UE 1f-01.

In step 1f-35, the USIM 1 UE 1f-02 may transmit UEAssistanceInformation including a musim-GapPreferenceList to the NW1 1f-04.

More specifically, the USIM 1 UE 1f-02 may transmit a predetermined RRC message (e.g., UEAssistanceInformation message) containing configuration information (MUSIM-GapPreferenceList) on one or more preferred MUSIM gap patterns to the NW1 1f-04. The MUSIM-GapPreferenceList may include information having the following ASN. 1 structure.

MUSIM-GapPreferenceList-r17 ::= SEQUENCE (SIZE (1..4)) OF MUSIM-GapInfo-r17
- MUSIM-GapInfo
The IE MUSIM-GapInfo is used to indicate MUSIM gap parameters.
MUSIM-GapInfo information element

[symbol]

[symbol]

| | |
|---|---|
| MUSIM-GapInfo-r17 ::= | SEQUENCE { |
| musim-Starting-SFN-AndSubframe-r17 | MUSIM Starting-SFN-AndSubframe-r17 |

OPTIONAL, -- Cond aperiodic

| | |
|---|---|
| musim-GapLength-r17 | ENUMERATED {ms3, ms4, ms6, ms10, ms20} |

OPTIONAL, -- Cond

[symbol]

| | |
|---|---|
| musim-GapRepetitionAndOffset-r17 | CHOICE { |
| ms20-r17 | INTEGER (0..19), |
| ms40-r17 | INTEGER (0..39), |
| ms80-r17 | INTEGER (0..79), |
| ms160-r17 | INTEGER (0..159), |
| ms320-r17 | INTEGER (0..319), |
| ms640-r17 | INTEGER (0..639), |
| ms1280-r17 | INTEGER (0..1279), |
| ms2560-r17 | INTEGER (0..2559), |
| ms5120-r17 | INTEGER (0..5119), |

```
    ...
  }
OPTIONAL -- Cond periodic
}
MUSIM Starting-SFN-Andsubframe-r17 ::= SEQUENCE {
```

| | |
|---|---|
| starting-SFN-r17 | INTEGER (0..1023), |
| startingSubframe-r17 | INTEGER (0..9) |

}

[symbol]

[symbol]

MUSIM-Gapinfo field descriptions
musim-GapLength
Indicates the length of the UE's MUSIM gap as specified in TS 38. 133 [14] clause 9.1.10. This field is mandatory
present for both periodic gap and aperiodic gap preference indication.
musim-GapRepetitionAndOffset
Indicates the gap repetition period in ms and gap offset in number of subframes for the periodic MUSIM gap as
specified in TS 38.133 [14] clause 9.1.10. This field is mandatory present for the periodic MUSIM gap preference
indication.
musim-Starting-SFN-AndSubframe
Indicates gap starting position for the aperiodic MUSIM gap. This field is optionally present for the aperiodic
MUSIM gap preference indication.
starting-SFN
Indicates gap starting SFN number for the aperiodic MUSIM gap.
startingSubframe
indicates gap starting subframe number for the aperiodic MUSIM gap. [symbol]
indicates data missing or illegible when filed

In step 1f-35, the USIM 1 UE 1f-02 may transmit a predetermined RRC message including a musim-GapPreferenceList to the NW1 1f-04 according to the following conditions. Table 2 to Table 4 may be referred to.

TABLE 2
5.7.4.2 Initiation

| 1> | if configured to provide MUSIM assistance information for gap preference: | |
|---|---|---|
| | 2> | if the UE has a preference on the MUSIM gap(s) and the UE did not transmit a |
| | | UEAssistanceInformation message with musim-GapPreferenceList since it was configured to provide |
| | | MUSIM assistance information for gap preference; or |
| | 2> | if the current musim-GapPreferenceList is different from the one indicated in the last transmission of |

| the UEAssistanceInformation message including musim-GapPreferenceList and the timer T346h is | |
|---|---|
| not running: | |
| 3> | initiate transmission of the UEAssistanceInformation message in accordance with 5.7.4.3 to |
| | provide the current musim-GapPreferenceList; |
| 3> | start or restart the timer T346h with the timer value set to the musim-GapProhibitTimer. |

| | |
|---|---|
| NOTE 3: | The UE does not need to initiate transmission of the UEAssistanceInformation message if the |
| | difference between the current musim-GapPreferenceList and the last transmission of the |
| | UEAssistanceInformation message including musim-GapPreferenceList is only due to removal of |
| | an ended aperiodic gap. |

TABLE 3
5.7.4.3 Actions related to transmission of UEAssistanceInformation message

| 1> | if transmission of the UEAssistanceinformation message is initiated to provide MUSIM assistance | |
|---|---|---|
| | information according to 5.7.4.2 or 5.3.5.3: | |
| | 2> | if the UE has a preference for MUSIM periodic gap(s): |

| | |
|---|---|
| 3> | include musim-GapPreferenceList with an entry for each periodic gap the UE prefers to be |

| configured; | |
|---|---|
| 4> | set musim-GapLength and musim-GapRepetition AndOffset in the musim-GapInfo IE to the |

values of the length and the repetition/offset of the gap(s), respectively, the UE prefers to be
configured with;

| | |
|---|---|
| 2> | if the UE has a preference for MUSIM aperiodic gap: |

| | |
|---|---|
| 3> | include the field musim-GapPreferenceList, with one entry for the aperiodic gap the UE prefers to |

| be configured; | |
|---|---|
| 4> | include musim-GapLength in the musim-GapInfo IE and set it to the values of the length of the |
| | gap the UE prefers to be configured with; |
| 4> | optionally include musim-Starting-SFN-AndSubframe in the musim-GapInfo JE and set it to |

the starting SFN/subframe of the gap the UE prefers to be configured with;

| | |
|---|---|
| 2> | if the UE has no longer preference for the periodic/aperiodic gaps: |

| | |
|---|---|
| 3> | do not include musim-GapPreferenceList in the musim-Assistance IE; |

TABLE 4
5.3.5.3 Reception of an RRCReconfiguration by the UE

| 1> | if reconfiguration WithSync was included in spCellConfig of an MCG or SCG, and when MAC of an NR | |
|---|---|---|
| | cell group successfully completes a Random Access procedure triggered above: | |
| | 2> | stop timer T304 for that cell group; |
| | 2> | stop timer T310 for source SpCell if running; |
| | 2> | apply the parts of the CSI reporting configuration, the scheduling request configuration and the |
| | | sounding RS configuration that do not require the UE to know the SEN of the respective target |
| | | SpCell, if any; |
| | 2> | apply the parts of the measurement and the radio resource configuration that require the UE to know |
| | | the SEN of the respective target SpCell (e.g. measurement gaps, periodic CQI reporting, scheduling |
| | | request configuration, sounding RS configuration), if any, upon acquiring the SFN of that target |
| | | SpCell; |
| | 2> | for each DRB configured as DAPS bearer, request uplink data switching to the PDCP entity, as |
| | | specified in TS 38.323 [5]; |
| | 2> | if the reconfiguration WithSync was included in spCellConfig of an MCG: |

| | |
|---|---|
| 3> | if T390 is running: |

| | |
|---|---|
| 4> | stop timer T390 for all access categories; |
| 4> | perform the actions as specified in 5.3.14.4. |

| | |
|---|---|
| 3> | if T350 is running; |

| | |
|---|---|
| 4> | stop timer T350; |

| | |
|---|---|
| 3> | if RRCReconfiguration does not include dedicatedSIBI-Delivery and |
| 3> | if the active downlink BWP, which is indicated by the firstActiveDownlinkBWP-Id for the target |
| | SpCell of the MCG, has a common search space configured by searchSpaceSIBI: |

| | |
|---|---|
| 4> | acquire the SIBI, which is scheduled as specified in TS 38.213 [13], of the target SpCell of the |
| | MCG; |
| 4> | upon acquiring SIBI, perform the actions specified in clause 5.2.2.4.2; |

| | |
|---|---|
| 2> | if the reconfiguration WithSync was included in spCellConfig of an MCG; or |
| 2> | if the reconfigurationWithSync was included in spCellConfig of an SCG and the CPA or CPC was |
| | configured |

| | |
|---|---|
| 3> | remove all the entries within VarConditionalReconfig, if any; |
| 3> | remove all the entries within VarConditionalReconfiguration as specified in TS 36,331 [10], |
| | clause 5.3.5.9.6, if any; |
| 3> | for each measld of the source SpCell configuration, if the associated reportConfig has a |
| | reportType set to condTriggerConfig: |

| | |
|---|---|
| 4> | for the associated reportConfigld: |

| | |
|---|---|
| 5> | remove the entry with the matching reportConfigld from the reportConfigList within the |
| | Var MeasConfig; |

| | |
|---|---|
| 4> | if the associated measObjectld is only associated to a reportConfig with reportType set to |
| | condTriggerConfig: |

| | |
|---|---|
| 5> | remove the entry with the matching measObjectld from the measObjectList within the |
| | VarMeasConfig; |

| | |
|---|---|
| 4> | remove the entry with the matching measld from the measldList within the Var MeasConfig; |

| | |
|---|---|
| 2> | if reconfiguration WithSync was included in masterGellGroup or secondaryCellGroup: |

| | |
|---|---|
| 3> | if the UE initiated transmission of a UEAssistanceInformation message for the corresponding cell |
| | group during the last 1 second, and the UE is still configured to provide the concerned UE |
| | assistance information for the corresponding cell group; or |
| 3> | if the RRCReconfiguration message is applied due to a conditional reconfiguration execution, and |
| | the UE is configured to provide UE assistance information for the corresponding cell group, and |
| | the UE has initiated transmission of a UEAssistanceInformation message for the corresponding |
| | cell group since it was configured to do so in accordance with 5.7.4.2; |

| | |
|---|---|
| 4> | initiate transmission of a UEAssistanceInformation message for the corresponding cell group |
| | in accordance with clause 5.7.4.3 to provide the concerned UE assistance information; |
| 4> | start or restart the prohibit timer (if exists) or the leave without response timer for the MUSIM |
| | associated with the concerned UE assistance information with the timer value set to the value |
| | in corresponding configuration; |

In step 1f-40, the NW1 1f-04 may transmit RRCReconfiguration including musim-GapConfig to the USIM 1 UE 1f-02.

More specifically, the NW1 1f-04 may transmit a predetermined RRC message (e.g., RRCReconfiguration) containing one or more MUSIM gap configuration information (musim-GapConfig) based on a musim-GapPreferenceList requested by the USIM 1 UE 1f-02 in response to step 1f-35. The musim-GapConfig may include information having the following ASN.1 structure.

- MUSIM-GapConfig
The IE MUSIM-GapConfig specifies the MUSIM gap configuration and controls setup/release of MUSIM gaps.

MUSIM-GapConfig information element

[symbol]

[symbol]

| | |
|---|---|
| MUSIM-GapConfig-r17 ::= | SEQUENCE { |
| musim-GaptoReleaseList-r17 | SEQUENCE (SIZE (1..3)) OF MUSIM-GapId-r17 |

OPTIONAL, -- Need N

| | |
|---|---|
| musim-GapToAddModList-r17 | SEQUENCE (SIZE (1..3)) OF MUSIM-Gap-r17 |

OPTIONAL, -- Need N

| | | |
|---|---|---|
| musim-AperiodicGap-r17 | MUSIM-GapInfo-r17 | OPTIONAL, -- Need N |

...
}

| | |
|---|---|
| MUSIM-Gap-r17 ::= | SEQUENCE { |
| musim-GapId-r17 | MUSIM-GapId-r17 |
| musim-GapInfo-117 | MUSIM-GapInfo-r17 |

}

[symbol]

[symbol]

MUSIM-GapConfig field descriptions
musim-AperiodicGap
Indicates the MUSIM aperiodic gap as specified in TS 38.133 [14] clause 9.1.10. If UE indicates the musim-
Starting-SFN-AndSubframe when requesting aperiodic gap the network can only configure the aperiodic gap
with the same start point or no aperiodic gap. If the field musim-Starting-SFN-AndSubframe is absent for
aperiodic gap, network can configure any timing as the starting point for aperiodic gap or configure no
aperiodic gap.
musim-Gapinfo
Indicates the values for musim-GapLength and musim-GapRepetitionAndOffset. When network provides
periodic gap, network always signals the musim-GapLength and musim-GapRepetitionAndOffset as indicated
by the UE's preferred MUSIM gap configuration.
musim-GapToAddModList
List of MUSIM periodic gap patterns to add or modify.
musim-GapToReleaseList
List of MUSIM periodic gap patterns to release. [symbol]
indicates data missing or illegible when filed

In step 1f-45, the USIM 1 UE 1f-02 may transmit an RRCReconfigurationComplete message to the NW1 1f-04.

More specifically, the USIM 1 UE 1f-02 may transmit a predetermined RRC message (e.g., RRCReconfigurationComplete) to the NW1 1f-04 in response to a predetermined RRC message received in step 1f-40.

In step 1f-50, in the case that each MUSIM gap occurs according to the MUSIM gap configuration received in step 1f-40, at least one of operations of step 1f-25 described above may be performed. In this case, the USIM 1 UE 1f-02 may maintain the RRC connected mode with the NW1 1f-04.

FIG. 1G is a signal flow diagram illustrating a method for a UE (multi-USIM UE, MUSIM UE) supporting multiple USIMs to perform an operation related to USIMs according to an embodiment of the disclosure.

Referring to FIG. 1G, it illustrates a signal flow diagram illustrating a process in which a multi-USIM UE (hereinafter, MUSIM UE) supporting multiple USIMs performs an operation associated with other USIMs while maintaining an RRC connected mode (RRC_CONNECTED) with a base station associated with one USIM.

A multi-USIM capable UE 1g-01 according to an embodiment of the disclosure may mean a UE that supports two or more USIMs. According to an embodiment of the disclosure, for convenience of description, a dual-USIM UE supporting two USIMs is considered. The dual-USIM UE has a feature of transmitting to a base station associated with one USIM at a given time or transmitting to a base station associated with each USIM. Similarly, the dual-USIM UE has a feature of receiving from a base station associated with one USIM at a given time or simultaneously receiving from a base station associated with each USIM.

Referring to FIG. 1G, the multi-USIM capable UE 1g-01 may mean a UE that supports multiple USIMs in one device. For example, the MUSIM UE may mean a USIM 1 UE 1g-02 in the case of operating in a USIM 1 and mean a USIM 2 UE 1g-03 in the case of operating in a USIM 2. The base station associated with each USIM may not recognize the MUSIM UE as one UE, but may recognize the MUSIM UE as one UE for each USIM UE. For example, the NW1 1g-04 may recognize a USIM 1 UE 1g-02 as one UE, and the NW2 1g-05 may recognize a USIM 2 UE 1g-03 as one UE.

Hereinafter, in the embodiments of the disclosure, for convenience of description, in the case that the MUSIM UE communicates using the USIM 1, the MUSIM UE is referred to as a USIM 1 UE, and in the case that the MUSIM UE communicates using the USIM 2, the MUSIM UE is referred to as a USIM 2 UE. For example, the MUSIM UE may be a USIM 1 UE or a USIM 2 UE according to which USIM between the USIM 1 and USIM 2 is used.

In step 1g-10, the USIM 1 UE 1g-02 may configure an RRC connection with the NW1 1g-04 to be in an RRC connected mode (RRC_CONNECTED).

In step 1g-10, the USIM 2 UE 1g-03 may not configure an RRC connection with the NW2 1g-05 to be in an RRC idle mode (RRC_IDLE) or an RRC inactive mode (RRC_INACTIVE).

The disclosure may be equally applied even to the case that the USIM 2 UE 1g-03 may configure an RRC connection with the NW2 1g-05 to be in an RRC connected mode (RRC_CONNECTED).

In step 1g-15, the USIM 1 UE 1g-02 may transmit a UE capability information message (UECapabilityInformation) to the NW1 1g-04.

This may follow the foregoing embodiment. Additionally, the UE capability information message may include the following information.
1-bit indicator indicating whether the UE 1g-02 supports a MUSIM gap priority configuration and preference to the NW1 1g-04, and the indicator is a per UE capability indicator and may not distinguish between xDD/FDD (1 optional per-UE capability bit (without xDD/FRx differentation) to indicate MUSIM gap priority configuration and preference). The UE may support the capability indicator in the case that it supports the capability (musim-GapPreference) of the foregoing embodiment.
Indicator indicating to the NW1 1g-04 that the USIM 1 UE 1g-02 supports a keep solution (e.g., 1 optional per-UE capability bit to indicate the support of applying keep solution)
The keep solution means that all colliding MUSIM gaps are maintained, and the UE may apply all colliding MUSIM gaps.
For reference, an indicator that supports a keep solution may not be included separately. In this case, in the case that the UE supports a 1-bit indicator indicating whether it supports a MUSIM gap priority configuration and preference, it may mean that a keep solution is also supported.

In step 1g-20, the NW1 1g-04 may transmit otherConfig to the USIM1 UE 1g-02.

More specifically, the NW1 1g-04 may transmit a predetermined RRC message (e.g., RRCReconfiguration message) including configuration information (musim-GapAssistanceConfig) that enables the USIM1 UE 1g-02 to report preferred/required MUSIM gap information for a MUSIM operation. Additionally, the musim-GapAssistanceConfig may be stored in otherConfig. This may follow the foregoing embodiment.

Additionally, the musim-GapAssistanceConfig according to an embodiment of the disclosure may include at least one of the following information.
An indicator reporting a gap priority preferred by the UE (e.g., one bit to indicate whether the UE can report MUSIM gap priority preference)
The indicator may have the advantage of preventing the UE from reporting this when the base station does not understand the gap priority preferred by the UE.
An indicator reporting whether the UE wants to maintain and use colliding MUSIM gaps without dropping them (e.g., one bit to indicate whether the UE wants to apply/use keep solution)

In step 1g-25, the USIM 2 UE 1g-03 may determine whether to perform required activities in an RRC idle mode or an RRC inactive mode. This may follow the foregoing embodiment.

In step 1g-30, the USIM 2 UE 1g-03 may notify the USIM 1 UE 1g-02 of information required to perform an operation of step 1g-25 in an RRC idle mode or an RRC inactive mode. This may follow the foregoing embodiment.

In step 1g-35, the USIM 1 UE 1g-02 may transmit UEAssistanceInformation to the NW1 1g-04.

More specifically, the USIM 1 UE 1g-02 may transmit a predetermined RRC message (e.g., UEAssistanceInformation message) containing configuration information (musim-GapPreferenceList) on one or more preferred MUSIM gap patterns to the NW1 1g-04. This may follow the foregoing embodiment.

Additionally, the UE may store a preferred gap priority for each periodic MUSIM gap pattern in the UEAssistanceInformation message due to step 1g-30. For reference, for an aperiodic MUSIM gap, the gap priority may not be stored in the UEAssistanceInformation message. This is because the aperiodic MUSIM gap is maintained even if it collides with any measurement gaps (all gaps including MUSIM gaps, MGs, or the like) and the UE applies this when configuring the aperiodic MUSIM gap.

The UE may set GapPriority-r17 considering a gap priority based on all measurement gaps for all preferred periodic MUSIM gap patterns. For example, the UE may set GapPriority-r17 to one integer value from 1 to 16 for each periodic MUSIM gap pattern. In this case, 1 may represent the highest priority, 2 may represent the next highest priority, and 16 may represent the lowest priority. Two or more periodic MUSIM gap patterns may be configured to the same gap priority.

In the above description, the UE may store an indicator wanting to maintain and apply colliding periodic MUSIM gaps in the UEAssistanceInformation. The indicator may be a 1-bit indicator or an indicator for each periodic MUSIM gap.

Alternatively, in the above description, the UE may store an indicator that it wants to maintain and apply all colliding MUSIM gaps (including an aperiodic MUSIM gap) in the UEAssistanceInformation message. The indicator may be a 1-bit indicator or an indicator for each MUSIM gap.

In step 1g-40, the NW1 1g-04 may transmit an RRCReconfiguration message including musim-GapConfig to the USIM 1 UE 1g-02.

More specifically, the NW1 1g-04 may transmit a predetermined RRC message (e.g., RRCReconfiguration) containing one or more MUSIM gap configuration information (musim-GapConfig) based on the musim-GapPreferenceList requested by the USIM 1 UE 1g-02 in response to step 1g-35. This may follow the foregoing embodiment.

Additionally, in an embodiment of the disclosure, the base station may configure a periodic MUSIM gap to the UE through the following methods.
The base station may configure a gap priority through GapPriority-r17 for all periodic MUSIM gaps in which the UE prefers and requests. In this case, the gap priority may be configured to a value requested by the UE or to another value.

For reference, GapPriority-r17 may be configured to an integer value from 1 to 16, 1 may represent the highest priority, and 2 may represent the next highest priority.

In the above description, the base station may not configure a separate gap priority for the aperiodic MUSIM gap.

In the above description, the base station may configure an indicator indicating to apply a keep solution to the UE for one or more MUSIM gaps. The indicator may be separately indicated only for periodic MUSIM gaps to which the keep solution is applied or only for all MUSIM gaps, or the indicator may be indicated to apply a keep solution for all colliding periodic MUSIM gaps or all colliding periodic MUSIM gaps and aperiodic MUSIM gap through 1 bit. For reference, in the above description, it may be explicitly indicated whether to apply a priority solution or a keep solution for the MUSIM gap.

Alternatively, in the above description, it may be indicated whether to apply a keep solution to the MUSIM gap. In this case, a gap priority may not be configured for the MUSIM gap to which a keep solution is applied.

In step 1g-45, the USIM 1 UE 1g-02 may transmit an RRCReonfigurationComplete message to the NW1 1g-04.

More specifically, the USIM 1 UE 1g-02 may transmit a predetermined RRC message to the NW1 1g-04 in response to a predetermined RRC message received in step 1g-40. For example, the predetermined RRC message may mean RRCReconfigurationComplete.

In step 1g-50, the NW1 1g-04 may transmit MeasGapConfig to the USIM 1 UE 1g-02.

More specifically, the NW1 1g-04 may transmit a predetermined RRC message (e.g., RRCReconfiguration message) containing measurement gap configuration information (MeasGapConfig) to the USIM 1 UE 1g-02. One or more GapConfig-r17 information may be stored in the MeasGapConfig. Specifically, Gap-Config-r17 may have ASN.1 structure and information illustrated in Table 5.

TABLE 5

| | |
|---|---|
| GapConfig-r17 ::= | SEQUENCE { |
| measGapId-r17 | MeasGapId-r17, |
| gapType-r17 | ENUMERATED {perUE, perFR1, perFR2}, |
| gapOffset-r17 | INTEGER (0..159), |
| mgl-r17 | ENUMERATED {ms1, ms1dot5, ms2, ms3, ms3dot5, ms4, |

ms5, ms5dot5, ms6, ms10, ms20},

| | |
|---|---|
| mgrp-r17 | ENUMERATED {ms20, ms40, ms80, ms160}, |
| mgta-r17 | ENUMERATED {ms0, ms0dot25, ms0dot5, ms0dot75}, |
| refServCellIndicator-r17 | ENUMERATED {pCell, pSCell, mcg-FR2} |

OPTIONAL, -- Cond NEDCorNRDC
refFR2-ServCellAsyncCA-r17 ServCellIndex
OPTIONAL, -- Cond AsyncCA

| | |
|---|---|
| preConfigInd-r17 | ENUMERATED {true} |
| OPTIONAL, -- Need R | |
| ncsgInd-r17 | ENUMERATED {true} |
| OPTIONAL, -- Need R | |
| gapAssociationPRS-r17 | ENUMERATED {true} |
| OPTIONAL, -- Need R | |
| gapSharing-r17 | MeasGapSharingScheme |
| OPTIONAL, -- Need R | |
| gapPriority-r17 | GapPriority-r17 |
| OPTIONAL, -- Need R | |
| ... | |
| } | |

According to an embodiment of the disclosure, type-2 MG means a gap configured to Gap-Config-r17, and in this case, type-2 MG may mean that preConfigInd-r17 and ncsgInd-r17 are not configured to true. Alternatively, type-2 MG may mean another MG known to a MUSIM gap. For reference, when the base station configures type-2 MG to the UE, the base station has a feature of not receiving UE assistance information but directly configuring a gap priority, unlike the MUSIM gap.

In step 1g-55, the USIM 1 UE 1g-02 may determine that the configured type-2 MG and the MUSIM gap to which the keep solution is applied overlap or collide in the time axis. In this case, the UE may maintain and apply the MUSIM gap to which the keep solution is applied. For example, the UE may perform an operation required for the USIM 2 UE 1g-03.

FIG. 1H is a signal flow diagram illustrating a method for a UE (multi-USIM UE, MUSIM UE) supporting multiple USIMs to perform an operation related to USIMs according to an embodiment of the disclosure.

Referring to FIG. 1H, it illustrates a signal flow diagram illustrating a process in which a multi-USIM UE (hereinafter, MUSIM UE) supporting multiple USIMs performs an operation associated with other USIMs while maintaining an RRC connected mode (RRC_CONNECTED) with a base station associated with one USIM.

A multi-USIM capable UE 1h-01 according to an embodiment of the disclosure may mean a UE that supports two or more USIMs. According to an embodiment of the disclosure, for convenience of description, a dual-USIM UE supporting two USIMs is considered. The dual-USIM UE has a feature of transmitting to a base station associated with one USIM at a given time or transmitting to a base station associated with each USIM. Similarly, the dual-USIM UE has a feature of receiving from a base station associated with one USIM at a given time or simultaneously receiving from a base station associated with each USIM.

Referring to FIG. 1H, the multi-USIM capable UE 1h-01 may mean a UE that supports multiple USIMs in one device. For example, the MUSIM UE may mean a USIM 1 UE 1h-02 in the case of operating in a USIM 1, and mean a USIM 2 UE 1h-03 in the case of operating in a USIM 2. A base station associated with each USIM may not recognize the MUSIM UE as one UE, but may recognize the MUSIM UE as one UE for each USIM UE. For example, the NW1 1h-04 may recognize a USIM 1 UE 1h-02 as one UE, and the NW2 1h-05 may recognize a USIM 2 UE 1h-03 as one UE.

Hereinafter, in embodiments of the disclosure, for convenience of description, in the case that the MUSIM UE communicates using the USIM 1, the MUSIM UE is referred to as a USIM 1 UE, and in the case that the MUSIM UE communicates using the USIM 2, the MUSIM UE is referred to as a USIM 2 UE. For example, the MUSIM UE may be a USIM 1 UE or a USIM 2 UE according to which USIM between the USIM 1 and USIM 2 is used.

In step 1h-10, the USIM 1 UE 1h-02 may configure an RRC connection with the NW1 1h-04 to be in an RRC connected mode (RRC_CONNECTED).

In step 1h-10, because the USIM 2 UE 1h-03 does not configure an RRC connection with the NW2 1h-05, the USIM 2 UE 1h-03 may be in an RRC idle mode (RRC_IDLE) or an RRC inactive mode (RRC_INACTIVE).

The disclosure may be equally applied even to the case that the USIM 2 UE 1h-03 may configure an RRC connection with the NW2 1h-05 to be in an RRC connected mode (RRC_CONNECTED).

In step 1h-15, the USIM 1 UE 1h-02 may transmit a UE capability information message (UECapabilityInformation) to the NW1 1h-04.

This may follow the foregoing embodiment. Additionally, the UE capability information message may include the following information.
1-bit indicator indicating whether the USIM 1 UE 1h-02 supports a MUSIM gap priority configuration and preference to the NW1 1h-04, and the indicator is a per UE capability indicator and may not distinguish between xDD/FDD (1 optional per-UE capability bit (without xDD/FRx differentation) to indicate MUSIM gap priority configuration and preference). The UE may support the capability indicator in the case that it supports the capability (musim-GapPreference) of the foregoing embodiment.
An indicator indicating to the NW1 1h-04 that the USIM 1 UE 1h-02 supports a keep solution (e.g., 1 optional per-UE capability bit to indicate the support of applying keep solution)
The keep solution means that all colliding MUSIM gaps are maintained, and the UE may apply all colliding MUSIM gaps.
For reference, an indicator that supports a keep solution may not be included separately. In this case, in the case that the UE supports a 1-bit indicator indicating whether it supports a MUSIM gap priority configuration and preference, it may mean that a keep solution is also supported.

In step 1h-20, the NW1 1h-04 may transmit otherConfig to the USIM1 UE 1h-02.

More specifically, the NW1 1h-04 may transmit a predetermined RRC message (e.g., RRCReconfiguration message) including configuration information (musim-GapAssistanceConfig) that enables the USIM1 UE 1h-02 to report preferred/required MUSIM gap information for a MUSIM operation. Additionally, the musim-GapAssistanceConfig may be stored in otherConfig. This may follow the foregoing embodiment.

Additionally, according to an embodiment of the disclosure, the musim-GapAssistanceConfig may include at least one of the following information.
An indicator reporting the gap priority preferred by the UE (e.g., one bit to indicate whether the UE can report MUSIM gap priority preference)
The indicator may have the advantage of preventing the UE from reporting this when the base station does not understand the gap priority preferred by the UE.
An indicator reporting whether the UE wants to maintain and use colliding MUSIM gaps without dropping them (e.g., one bit to indicate whether the UE wants to apply/use keep solution)

In step 1h-25, the USIM 2 UE 1h-03 may determine whether it should perform required activities in an RRC idle mode or an RRC inactive mode. This may follow the foregoing embodiment.

In step 1h-30, the USIM 2 UE 1h-03 may notify the USIM 1 UE 1h-02 of information required to perform an operation of step 1h-25 in an RRC idle mode or an RRC inactive mode. This may follow the foregoing embodiment.

In step 1h-35, the USIM 1 UE 1h-02 may transmit UEAssistanceInformation to the NW1 1h-04.

More specifically, the USIM 1 UE 1h-02 may transmit a predetermined RRC message (e.g., UEAssistanceInformation message) containing configuration information (musim-GapPreferenceList) on one or more preferred MUSIM gap patterns to the NW1 1h-04. This may follow the foregoing embodiment.

Additionally, the UE may store the preferred gap priority for each periodic MUSIM gap pattern in the UEAssistanceInformation message due to step 1h-30. For reference, for an aperiodic MUSIM gap, the gap priority may not be stored in the UEAssistanceInformation message. This is because the aperiodic MUSIM gap is maintained even if it collides with any measurement gap (all gaps including MUSIM gaps, MGs, or the like) and the UE applies this when configuring the aperiodic MUSIM gap.

The UE may set GapPriority-r17 considering a gap priority based on all measurement gaps for all preferred periodic MUSIM gap patterns. For example, the UE may set GapPriority-r17 to one integer value from 1 to 16 for each periodic MUSIM gap pattern. In this case, 1 may represent the highest priority, 2 may represent the next highest priority, and 16 may represent the lowest priority. Two or more periodic MUSIM gap patterns may be configured to the same gap priority.

In the above description, the UE may store an indicator wanting to maintain and apply colliding periodic MUSIM gaps in the UEAssistanceInformation message. The indicator may be a 1-bit indicator or an indicator for each periodic MUSIM gap.

Alternatively, in the above description, the UE may store an indicator wanting to maintain and apply all colliding MUSIM gaps (including aperiodic MUSIM gap) in the UEAssistanceInformation message. The indicator may be a 1-bit indicator or an indicator for each MUSIM gap. In the above description, the UE may store an indicator about which gap (MUSIM gap or type-2 MG) to use in the case that MUSIM gaps to which the keep solution is applied and the type-2 MG collide in the UEAssistanceInformation message.

In step 1h-40, the NW1 1h-04 may transmit an RRCReconfiguration message including musim-GapConfig to the USIM1 UE 1h-02.

More specifically, the NW1 1h-04 may transmit a predetermined RRC message (e.g., RRCReconfiguration) containing one or more MUSIM gap configuration information (musim-GapConfig) based on a musim-GapPreferenceList requested by the USIM 1 UE 1h-02 in response to step 1h-35. This may follow the foregoing embodiment.

Additionally, in an embodiment of the disclosure, the base station may configure a periodic MUSIM gap to the UE through the following methods.
The base station may configure a gap priority through GapPriority-r17 to all periodic MUSIM gaps in which the UE prefers and requests. In this case, the gap priority may be configured to a value requested by the UE or to another value.

For reference, GapPriority-r17 may be configured to an integer value from 1 to 16. 1 may represent the highest priority, and 2 may represent the next highest priority. In the above description, the base station may not separately configure a gap priority to the aperiodic MUSIM gap.

In the above description, the base station may configure an indicator indicating to apply the keep solution to one or more MUSIM gaps to the UE. The indicator may be separately indicated only for periodic MUSIM gaps to which the keep solution is applied or only for all MUSIM gaps, or the indicator may be indicted to apply the keep solution to all colliding periodic MUSIM gaps or all colliding periodic MUSIM gaps and aperiodic MUSIM gap through 1 bit.

For reference, in the above description, it may be explicitly indicated whether to apply the priority solution or the keep solution to the MUSIM gap. Alternatively, in the above description, it may be indicated whether to apply the keep solution to the MUSIM gap. In this case, the gap priority may not be configured to the MUSIM gap to which the keep solution is applied. In the above description, an indicator may be included indicating which gap (MUSIM gap or type-2 MG) to use in the case that MUSIM gaps to which the keep solution is applied collides with type-2 MG.

In step 1h-45, the USIM 1 UE 1h-02 may transmit an RRCReonfigurationComplete message to the NW1 1h-04.

More specifically, the USIM 1 UE 1h-02 may transmit a predetermined RRC message to the NW1 1h-04 in response to a predetermined RRC message received in step 1h-40. For example, the predetermined RRC message may mean RRCReconfigurationComplete.

In step 1h-50, the NW1 1h-04 may transmit MeasGapConfig to the USIM1 UE 1h-02.

More specifically, the NW1 1h-04 may transmit a predetermined RRC message (e.g., RRCReconfiguration message) containing measurement gap configuration information (MeasGapConfig) to the USIM 1 UE 1h-02. One or more GapConfig-r17 information may be stored in the MeasGapConfig. Specifically, Gap-Config-r17 may have an ASN.1 structure and information illustrated in Table 6.

TABLE 6

| | |
|---|---|
| GapConfig-r17 ::= | SEQUENCE { |
| measGapId-r17 | MeasGapId-r17, |
| gapType-r17 | ENUMERATED {perUE, perFR1, perFR2}, |
| gapOffset-r17 | INTEGER (0..159), |
| mgl-r17 | ENUMERATED {ms1, ms1dot5, ms2, ms3, ms3dot5, ms4, |

ms5, ms5dot5, ms6, ms10, ms20},

| | |
|---|---|
| mgrp-r17 | ENUMERATED {ms20, ms40, ms80, ms160}, |
| mgta-r17 | ENUMERATED {ms0, ms0dot25, ms0dot5, ms0dot75 }, |
| refServCellIndicator-r17 | ENUMERATED {pCell, pSCell, mcg-FR2} |

OPTIONAL, -- Cond NEDCorNRDC

| | | |
|---|---|---|
| refFR2-ServCellAsyncCA-r17 | ServCellIndex | OPTIONAL, |

-- Cond AsyncCA

| | | |
|---|---|---|
| preConfigInd-r17 | ENUMERATED { true} | OPTIONAL, |

-- Need R

| | | |
|---|---|---|
| ncsgInd-r17 | ENUMERATED { true} | OPTIONAL, |

-- Need R

| | |
|---|---|
| gap AssociationPRS-r17 | ENUMERATED {true} |

OPTIONAL, -- Need R

| | | |
|---|---|---|
| gapSharing-r17 | MeasGapSharingScheme | OPTIONAL, |

-- Need R

| | | |
|---|---|---|
| gapPriority-r17 | GapPriority-r17 | OPTIONAL, |

-- Need R
...
}

In an embodiment of the disclosure, type-2 MG means a gap configured to Gap-Config-r17, and in this case, type-2 MG may mean that preConfigInd-r17 and ncsgInd-r17 are not configured to true. Alternatively, type-2 MG may mean another MG known to a MUSIM gap. For reference, when the base station configures type-2 MG to the UE, the base station has a feature of not receiving UE assistance information but directly configuring a gap priority, unlike the MUSIM gap.

In step 1h-55, the USIM 1 UE 1h-02 may determine that the configured type-2 MG and the MUSIM gap to which the keep solution is applied overlap or collide on the time axis. In this case, the UE may determine and apply whether to maintain and apply the MUSIM gap to which the keep solution is applied or to apply the type-2 MG according to a configuration of the base station.

FIG. 1I is a signal flow diagram illustrating a method for a UE (multi-USIM UE, MUSIM UE) supporting multiple USIMs to perform an operation related to USIMs according to an embodiment of the disclosure.

Referring to FIG. 1I, it illustrates a signal flow diagram illustrating a process in which a multi-USIM UE (hereinafter, MUSIM UE) supporting multiple USIMs performs an operation associated with other USIMs while maintaining an RRC connected mode (RRC_CONNECTED) with a base station associated with one USIM.

A multi-USIM capable UE 1i-01 according to an embodiment of the disclosure may mean a UE that supports two or more USIMs. According to an embodiment of the disclosure, for convenience of description, a dual-USIM UE supporting two USIMs is considered. The dual-USIM UE has a feature of transmitting to a base station associated with one USIM at a given time or transmitting to a base station associated with each USIM. Similarly, the dual-USIM UE has a feature of receiving from a base station associated with one USIM at a given time or simultaneously receiving from a base station associated with each USIM.

Referring to FIG. 1I, the multi-USIM capable UE 1i-01 may mean a UE that supports multiple USIMs in one device. For example, the multi-USIM capable UE may mean a USIM 1 UE 11-02 in the case of operating in an USIM 1 and mean a USIM 2 UE 1i-03 in the case of operating in an USIM 2. A base station associated with each USIM may not recognize the MUSIM UE as one UE, but may recognize the MUSIM UE as one UE for each USIM UE. For example, a NW1 1i-04 may recognize a USIM 1 UE 1i-02 as one UE, and a NW2 1i-05 may recognize a USIM 2 UE 1i-03 as one UE. Hereinafter, in embodiments of the disclosure, for convenience of description, in the case that the MUSIM UE communicates using the USIM 1, the MUSIM UE is referred to as a USIM 1 UE, and in the case that the MUSIM UE communicates using the USIM 2, the MUSIM UE is referred to as a USIM 2 UE. For example, the MUSIM UE may be a USIM 1 UE or a USIM 2 UE according to which USIM between the USIM 1 and the USIM 2 is used.

In step 1i-10, the USIM 1 UE 1i-02 may configure an RRC connection with the NW1 1i-04 to be in an RRC connected mode (RRC_CONNECTED).

In step 1i-10, the USIM 2 UE 1i-03 may not configure an RRC connection with the NW2 li-05 to be in an RRC idle mode (RRC_IDLE) or an RRC inactive mode (RRC_INACTIVE).

The disclosure may be equally applied even to the case that the USIM 2 UE 1i-03 may configure an RRC connection with the NW2 li-05 to be in an RRC connected mode (RRC_CONNECTED).

In step 1i-15, the USIM 1 UE 1i-02 may transmit a UE capability information message (UECapabilityInformation) to the NW1 1i-04. This may follow the foregoing embodiment. Additionally, the UE capability information message may include the following information.
1-bit indicator indicating whether the UE 1i-02 supports a MUSIM gap priority configuration and preference to the NW1 li-04, and the indicator is a per UE capability indicator, and may not distinguish between xDD/FDD (1 optional per-UE capability bit (without xDD/FRx differentation) to indicate MUSIM gap priority configuration and preference). In the case that the UE supports the capability (musim-GapPreference) of the foregoing embodiment or the disclosure, the UE may support the capability indicator.
An indicator indicating to the NW1 li-04 that the USIM 1 UE 1i-02 supports a keep solution (e.g., 1 optional per-UE capability bit to indicate the support of applying keep solution)
The keep solution means that all colliding MUSIM gaps are maintained, and the UE may apply all colliding MUSIM gaps.
For reference, an indicator that supports a keep solution may not be included separately. In this case, in the case that the UE supports a 1-bit indicator indicating whether it supports a MUSIM gap priority configuration and preference, it may mean that a keep solution is also supported.

In step 1i-20, the NW1 1i-04 may transmit otherConfig to the USIM 1 UE 1i-02.

More specifically, the NW1 li-04 may transmit a predetermined RRC message (e.g., RRCReconfiguration message) including configuration information (musim-GapAssistanceConfig) that enables the USIM1 UE 1i-02 to report preferred/required MUSIM gap information for a MUSIM operation. Additionally, the musim-GapAssistanceConfig may be stored in otherConfig. This may follow the foregoing embodiment.

Additionally, according to an embodiment of the disclosure, the musim-GapAssistanceConfig may include at least one of the following information.
An indicator reporting the gap priority preferred by the UE (e.g., one bit to indicate whether the UE can report MUSIM gap priority preference)
The indicator may have the advantage of preventing the UE from reporting this when the base station does not understand the gap priority preferred by the UE.
An indicator reporting whether the UE wants to maintain and use colliding MUSIM gaps without dropping them (e.g., one bit to indicate whether the UE wants to apply/use keep solution)

In step 1i-25, the USIM 2 UE 1i-03 may determine whether it should perform required activities in an RRC idle mode or an RRC inactive mode. This may follow the foregoing embodiment.

In step 1i-30, the USIM 2 UE 1i-03 may notify the USIM 1 UE 1i-02 of required information in order to perform an operation in step 1i-25 in an RRC idle mode or an RRC inactive mode. This may follow the foregoing embodiment.

In step 1i-35, the USIM 1 UE 11-02 may transmit UEAssistanceInformation to the NW1 1i-04.

More specifically, the USIM 1 UE 1i-02 may transmit a predetermined RRC message (e.g., UEAssistanceInformation message) containing configuration information (musim-GapPreferenceList) on one or more preferred MUSIM gap patterns to the NW1 1i-04. This may follow the foregoing embodiment.

Additionally, the UE may store a preferred gap priority for each periodic MUSIM gap pattern in the UEAssistanceInformation message due to step 1i-30. For reference, for an aperiodic MUSIM gap, the gap priority may not be stored in the UEAssistanceInformation message. This is because the aperiodic MUSIM gap is maintained even if it collides with any measurement gap (all gaps including MUSIM gaps, MGs, or the like) and the UE applies this when configuring the aperiodic MUSIM gap.

The UE may set GapPriority-r17 considering a gap priority based on all measurement gaps for all preferred periodic MUSIM gap patterns. For example, the UE may set GapPriority-r17 to one integer value from 1 to 16 for each periodic MUSIM gap pattern. In this case, 1 may represent the highest priority, 2 may represent the next highest priority, and 16 may represent the lowest priority. Two or more periodic MUSIM gap patterns may be configured to the same gap priority.

In the above description, the UE may store an indicator wanting to maintain and apply colliding periodic MUSIM gaps in the UEAssistanceInformation message. The indicator may be a 1-bit indicator or an indicator for each periodic MUSIM gap.

Alternatively, in the above description, the UE may store an indicator wanting to maintain and apply all colliding MUSIM gaps (including aperiodic MUSIM gap) in the UEAssistanceInformation message. The indicator may be a 1-bit indicator or an indicator for each MUSIM gap. In the above description, in the case that MUSIM gaps to which the keep solution is applied and the type-2 MG collide, an indicator about which gap (MUSIM gap or type-2 MG) wants to use may be stored in the UEAssistanceInformation message.

In step 1i-40, the NW1 li-04 may transmit an RRCReconfiguration message including musim-GapConfig to the USIMM 1 UE 1i-02.

More specifically, the NW1 li-04 may transmit a predetermined RRC message (e.g., RRCReconfiguration) containing one or more MUSIM gap configuration information (musim-GapConfig) based on a musim-GapPreferenceList requested by the USIM 1 UE 1i-02 in response to step 1i-35. This may follow the foregoing embodiment. Additionally, in an embodiment of the disclosure, the base station may configure a periodic MUSIM gap to the UE through the following methods.
The base station may configure a gap priority through GapPriority-r17 for all periodic MUSIM gaps in which the UE prefers and requests. In this case, the gap priority may be configured to a value requested by the UE or to another value.

For reference, GapPriority-r17 may be configured to an integer value from 1 to 16. 1 may represent the highest priority, and 2 may represent the next highest priority. In the above description, the base station may not separately configure a gap priority for the aperiodic MUSIM gap.

In the above description, the base station may configure an indicator indicating to apply the keep solution to the UE for one or more MUSIM gaps. The indicator may be separately indicated only for periodic MUSIM gaps to which the keep solution is applied or only for all MUSIM gaps, or the indicator may be indicated to apply the keep solution for all colliding periodic MUSIM gaps or all colliding periodic MUSIM gaps and aperiodic MUSIM gap through 1 bit.

For reference, in the above description, it may be explicitly indicated whether to apply the priority solution or the keep solution to the MUSIM gap. Alternatively, in the above description, it may be indicated whether to apply the keep solution to the MUSIM gap. In this case, a gap priority may not be configured to the MUSIM gap to which the keep solution is applied.

In step 1i-45, the USIM 1 UE 1i-02 may transmit an RRCReconfigurationComplete message to the NW1 1i-04.

More specifically, the USIM 1 UE 1i-02 may transmit a predetermined RRC message to the NW1 li-04 in response to a predetermined RRC message received in step 1i-40. For example, the predetermined RRC message may mean RRCReconfigurationComplete.

In step 1i-50, the NW1 li-04 may transmit MeasGapConfig to the USIM 1 UE 1i-02.

More specifically, the NW1 li-04 may transmit a predetermined RRC message (e.g., RRCReconfiguration message) containing measurement gap configuration information (MeasGapConfig) to the USIM 1 UE 1i-02. One or more GapConfig-r17 information may be stored in the MeasGapConfig. Specifically, Gap-Config-r17 may have an ASN.1 structure and information as illustrated in Table 7.

TABLE 7

| | |
|---|---|
| GapConfig-r17 ::= | SEQUENCE { |
| measGapId-r17 | MeasGapId-r17, |
| gap Type-r17 | ENUMERATED {perUE, perFR1, perFR2}, |
| gapOffset-r17 | INTEGER (0..159), |
| mgl-r17 | ENUMERATED {ms1, ms1dot5, ms2, ms3, ms3dot5, ms4, |

ms5, ms5dot5, ms6, ms10, ms20},

| | |
|---|---|
| mgrp-r17 | ENUMERATED {ms20, ms40, ms80, ms160}, |
| mgta-r17 | ENUMERATED {ms0, ms0dot25, ms0dot5, ms0dot75}, |
| refServCellIndicator-r17 | ENUMERATED {pCell, pSCell, mcg-FR2} |

OPTIONAL, -- Cond NEDCorNRDC

| | | |
|---|---|---|
| refFR2-ServCellAsyncCA-r17 | ServCellIndex | OPTIONAL, |

-- Cond AsyncCA

| | | |
|---|---|---|
| preConfigInd-r17 | ENUMERATED {true} | OPTIONAL, |

-- Need R

| | | |
|---|---|---|
| ncsgInd-r17 | ENUMERATED { true} | OPTIONAL, |

-- Need R

| | |
|---|---|
| gapAssociationPRS-r17 | ENUMERATED {true} |

OPTIONAL, -- Need R

| | | |
|---|---|---|
| gapSharing-r17 | MeasGapSharingScheme | OPTIONAL, |

-- Need R

| | | |
|---|---|---|
| gapPriority-r17 | GapPriority-r17 | OPTIONAL, |

-- Need R
...
}

In an embodiment of the disclosure, type-2 MG means a gap configured to Gap-Config-r17, and in this case, type-2 MG may mean that preConfigInd-r17 and ncsgInd-r17 are not configured to true. Alternatively, type-2 MG may mean another MG known to a MUSIM gap. For reference, when the base station configures type-2 MG to the UE, the base station has a feature of not receiving UE assistance information but directly configuring a gap priority, unlike a MUSIM gap.

In step 1i-55, the USIM 1 UE 1i-02 may determine that the configured type-2 MG and the MUSIM gap to which the keep solution is applied overlap or collide in the time axis. In this case, the UE may compare the highest gap priority of MUSIM gaps configured to use keep solution and the gap priority of type-2 MG.

For example, in the case that the highest gap priority among MUSIM gaps to which the keep solution is applied is 1 and that the priority of type-2 MG is 2, the MUSIM gaps to which the keep solution is applied may be applied and the type-2 MG may be dropped (Then, apply gap of higher gap priority). For reference, the UE may regard an aperiodic MUSIM gap as the highest gap priority (i.e., the gap priority is 1).

FIG. 1J is a flowchart illustrating a method for a UE (multi-USIM UE, MUSIM UE) supporting multiple USIMs to perform an operation related to USIMs according to an embodiment of the disclosure.

Referring to FIG. 1J, it illustrates a flowchart illustrating a process in which a multi-USIM UE (hereinafter, MUSIM UE) supporting multiple USIMs performs an operation associated with other USIMs while maintaining an RRC connected mode (RRC_CONNECTED) with a base station associated with one USIM.

Referring to FIG. 1J, the MUSIM UE may mean a UE that supports multiple (two or more) USIMs in one device. This may follow at least one of the foregoing embodiments.

In step 1j-05, the MUSIM UE may be configured to provide MUSIM assistance information for a gap priority. This may follow at least one of the foregoing embodiments.

In step 1j-10, the MUSIM UE may determine whether at least one of the following conditions is satisfied (Need to initiate transmission of the UEAssistanceInformation message to provide current musim-GapPrioirtyPreferenceList?).
Condition 1: In the case that the UE has a preference on the MUSIM gap(s) priority and that the UE did not transmit a UEAssistanceInformation message with musim-GapPriorityPreferenceList because it was configured to provide MUSIM assistance information for gap priority preference
Condition 2: In the case that the current musim-GapPriorityPreferenceList is different from the one indicated in the last transmission of the UEAssistanceInformation message including musim-GapPriorityPreferenceList

Condition In 3: the case that the current musim-GapPriorityPreferenceList is different from the one indicated in the last transmission of the UEAssistanceInformation message including musim-GapPriorityPreferenceList and that a prohibit timer for this is not running

In step 1j-15, the MUSIM UE may include the musim-GapPriorityPreferenceList the UE prefers to be configured in the UEAssistanceInformation message.

In the case that the UE has a preference for using a keep solution, the UE may include the keep solution information the UE prefers to be configured in the UEAssistanceInformation message. The keep solution information may follow at least one of the foregoing embodiments. The UE may transmit UEAssistanceInformation to the base station. For reference, the UE may run or rerun a prohibit timer when initiating the UEAssistanceInformation.

The UE according to the disclosure has a feature of not triggering a separate UEAssistanceInformation transmission procedure in order to send only keep solution information preference. For example, the UE has a feature of including together keep solution information when it wants to send the musim-GapPriorityPreferenceList the UE prefers to be configured.

FIG. 1K is a flowchart illustrating a method for a UE (multi-USIM UE, MUSIM UE) supporting multiple USIMs to perform an operation related to USIMs according to an embodiment of the disclosure.

Referring to FIG. 1K, it illustrates a diagram illustrating a process in which a multi-USIM UE (hereinafter, MUSIM UE) supporting multiple USIMs performs an operation associated with other USIMs while maintaining an RRC connected mode (RRC_CONNECTED) with a base station associated with one USIM.

Referring to FIG. 1K, the MUSIM UE may mean a UE that supports multiple (two or more) USIMs in one device. This may follow the foregoing embodiment.

In step 1k-05, the MUSIM UE may be configured to provide MUSIM assistance information for gap priority preference. This may follow the foregoing embodiment.

In step 1k-10, the MUSIM UE may determine whether at least one of the following conditions is satisfied (Need to initiate transmission of the UEAssistanceInformation message to provide current keep solution preference?).
Condition 1: In the case that the UE has a preference on the MUSIM gap(s) priority and that the UE did not transmit a UEAssistanceInformation message with musim-GapPriorityPreferenceList because it was configured to provide MUSIM assistance information for gap priority preference
Condition 2: In the case that the current musim-GapPriorityPreferenceList is different from the one indicated in the last transmission of the UEAssistanceInformation message including musim-GapPriorityPreferenceList
Condition 3: In the case that the current musim-GapPriorityPreferenceList is different from the one indicated in the last transmission of the UEAssistanceInformation message including musim-GapPriorityPreferenceList and that a prohibit timer for this is not running.
Condition 4: In the case that the UE has a preference on the MUSIM gap(s) priority and that the UE did not transmit a UEAssistanceInformation message with musim-GapPriorityPreferenceList because it was configured to provide MUSIM assistance information for keep priority preference

In the case that the current keep solution application preference of the UE is different from the keep solution application preference most recently transmitted and indicated in UEAssistanceInformation.
Condition 6: In the case that the current keep solution application preference of the UE is different from the keep solution application preference most recently transmitted and indicated in UEAssistanceInformation and that the prohibit timer is not running.
The prohibit timer may mean a prohibit timer different from that of the condition 3 or may mean the same prohibit timer as that of the condition 3.

In step 1k-15, in the case that the UE include a musim-GapPriorityPreferenceList the UE prefers to be configured), the UE may store the musim-GapPriorityPreferenceList in the UEAssistanceInformation message.

In the case that the UE has a preference for using keep solution, the UE may include the keep solution information the UE prefers to be configured in the UEAssistanceInformation message. The keep solution information may follow at least one of the foregoing embodiments. The UE may transmit UEAssistanceInformation to the base station. For reference, the UE may run or rerun a prohibit timer when initiating the UEAssistanceInformation. For reference, in the case that a musim-GapPriorityPreferenceList has never been sent, the UE may not store only keep solution information in the UEAssistanceInformation message.

The UE according to an embodiment of the disclosure has a feature that may trigger a UEAssistanceInformation transmission procedure so as to send only keep solution information preference.

FIG. 1L is a block diagram illustrating an internal structure of a UE according to an embodiment of the disclosure.

Referring to FIG. 1L, the UE may include a radio frequency (RF) processer 11-10, a baseband processer 11-20, a storage 11-30, and a controller 11-40.

The RF processer 11-10 may perform a function for transmitting and receiving signals through a wireless channel, such as signal band conversion and amplification. For example, the RF processer 11-10 may up-convert a baseband signal provided from the baseband processer 11-210 into an RF band signal, transmit the RF band signal through an antenna, and down-convert an RF band signal received through the antenna into a baseband signal. For example, the RF processer 11-10 may include a transmission filter, a reception filter, an amplifier, a mixer, an oscillator, a digital to analog convertor (DAC), an analog to digital convertor (ADC), and the like. In the drawing, only one antenna is illustrated, but the UE may be equipped with multiple antennas. Further, the RF processer 11-10 may include multiple RF chains. Furthermore, the RF processer 11-10 may perform beamforming. For the above beamforming, the RF processer 11-10 may adjust a phase and size of each of signals transmitted and received through multiple antennas or antenna elements. Further, the RF processer may perform MIMO and receive multiple layers when performing a MIMO operation.

The baseband processer 11-20 may perform a conversion function between a baseband signal and a bit string according to the physical layer specification of the system. For example, when transmitting data, the baseband processer 11-20 may encode and modulate a transmitted bit string to generate complex symbols. Further, when receiving data, the baseband processer 11-20 may demodulate and decode a baseband signal provided from the RF processer 11-10 to restore a received bit string. For example, in the case of following an orthogonal frequency division multiplexing (OFDM) method, when transmitting data, the baseband processer 11-20 may encode and modulate a transmitted bit string to generate complex symbols, map the complex symbols into subcarriers, and then constitute OFDM symbols through inverse fast Fourier transform (IFFT) operation and cyclic prefix (CP) insertion. Further, when receiving data, the baseband processer 11-20 divides the baseband signal provided from the RF processer 11-10 into OFDM symbol units, restore signals mapped to subcarriers through fast Fourier transform (FFT), and then restores the received bit string through demodulation and decoding.

The baseband processer 11-20 and the RF processer 11-10 may transmit and receive signals, as described above. Accordingly, the baseband processer 11-20 and the RF processer 11-10 may be referred to as a transmitter, a receiver, a transceiver, or a communication unit. Furthermore, at least one of the baseband processer 11-20 or the RF processer 11-10 may include a plurality of communication modules so as to support a plurality of different wireless access technologies. Further, at least one of the baseband processer 11-20 or the RF processer 11-10 may include different communication modules so as to process signals of different frequency bands. For example, the different wireless access technologies may include a wireless LAN (e.g., IEEE 802.11), a cellular network (e.g., LTE), and the like. Further, the different frequency bands may include a super high frequency (SHF) (e.g., 2.NRHz, NRhz) band, and a millimeter wave (e.g., 60 GHz) band.

The storage 11-30 may store data, such as a basic program, an application program, and configuration information for an operation of the UE. More particularly, the storage 11-30 may store information related to a second access node that performs wireless communication using second wireless access technology. The storage 11-30 provides stored data according to a request from the controller 11-40.

The controller 11-40 may include a multi-connection processor 11-42 and may control the overall operations of the UE. For example, the controller 11-40 may transmit and receive signals through the baseband processer 11-20 and the RF processer 11-10. Further, the controller 11-40 records and reads data in the storage 11-40. For this purpose, the controller 11-40 may include at least one processor. For example, the controller 11-40 may include a communication processor (CP) that performs the control for communication and an application processor (AP) that controls upper layers, such as application programs.

FIG. 1M is a block diagram illustrating an internal structure of a new radio (NR) base station according to an embodiment of the disclosure.

Referring to FIG. 1M, the base station may include an RF processer 1m-10, a baseband processer 1m-20, a backhaul communication unit 1m-30, a storage 1m-40, and a controller 1m-50. The RF processer 1m-10 may perform a function for transmitting and receiving signals through a wireless channel, such as signal band conversion and amplification. For example, the RF processer 1m-10 may up-convert a baseband signal provided from the baseband processer 1m-20 into an RF band signal, transmit the RF band signal through an antenna, and down-convert an RF band signal received through the antenna into a baseband signal. For example, the RF processer 1m-10 may include a transmission filter, a reception filter, an amplifier, a mixer, an oscillator, a DAC, an ADC, and the like. In the drawing, only one antenna is illustrated, but a first access node may be equipped with a plurality of antennas. Further, the RF processer 1m-10 may include a plurality of RF chains. Furthermore, the RF processer 1m-10 may perform beamforming. For the beamforming, the RF processer 1m-10 may adjust a phase and size of each of signals transmitted and received through a plurality of antennas or antenna elements. The RF processer may transmit one or more layers to perform a downlink MIMO operation.

The baseband processer 1m-20 may perform a conversion function between a baseband signal and a bit string according to the physical layer standard of first wireless access technology. For example, when transmitting data, the baseband processer 1m-20 may encode and modulate a transmitted bit string to generate complex symbols. Further, when receiving data, the baseband processer 1m-20 may demodulate and decode a baseband signal provided from the RF processer 1m-10 to restore a received bit string. For example, in the case of following an OFDM method, when transmitting data, the baseband processer 1m-20 may encode and modulate a transmitted bit string to generate complex symbols, map the complex symbols into subcarriers, and then constitute OFDM symbols through IFFT operation and CP insertion. Further, when receiving data, the baseband processer 1m-20 may divide a baseband signal provided from the RF processer 1m-10 into OFDM symbol units, restore signals mapped to subcarriers through FFT operation, and then restore the received bit string through demodulation and decoding. The baseband processer 1m-20 and the RF processer 1m-10 transmit and receive signals, as described above. Accordingly, the baseband processer 1m-20 and the RF processer 1m-10 may be referred to as a transmitter, a receiver, a transceiver, a communication unit, or a RF unit.

The backhaul communication unit 1m-30 may provide an interface for performing communication with other nodes within the network. For example, the backhaul communication unit 1m-30 converts a bit string transmitted from a main base station to another node, for example, an auxiliary base station, and a core network into a physical signal, and converts a physical signal received from the other node into a bit string.

The storage 1m-40 may include a multi-connection processor 1m-52 and may store data, such as a basic program, an application program, and configuration information for an operation of the main base station. More particularly, the storage 1m-40 may store information on bearers allocated to accessed UEs, measurement results reported from accessed UEs, and the like. Further, the storage 1m-40 may store information that serves as a determination criterion for whether to provide or to terminate multiple connections to the UE. The storage 1m-40 provides stored data according to a request from the controller 1m-50.

The controller 1m-50 may control the overall operations of the main base station. For example, the controller 1m-50 may transmit and receive signals through the baseband processer 1m-20 and the RF processer 1m-10 or through the backhaul communication unit 1m-30. Further, the controller 1m-50 records and reads data in the storage 1m-40. For this purpose, the controller 1m-50 may include at least one processor.

FIG. 1N is a signal flow diagram illustrating a method for a UE (multi-USIM UE, MUSIM UE) supporting multiple USIMs to perform an operation related to USIMs according to an embodiment of the disclosure.

Referring to FIG. 1N, it illustrates is a signal flow diagram illustrating a process in which a multi-USIM UE (hereinafter, MUSIM UE) supporting multiple USIMs performs an operation associated with other USIMs while maintaining an RRC connected mode (RRC_CONNECTED) with a base station associated with one USIM.

A multi-USIM capable UE 1n-01 according to an embodiment of the disclosure may mean a UE that supports two or more USIMs. According to an embodiment of the disclosure, for convenience of description, a dual-USIM UE supporting two USIMs is considered. The dual-USIM UE has a feature of transmitting to a base station associated with one USIM at a given time or transmitting to a base station associated with each USIM. Similarly, the dual-USIM UE has a feature of receiving from a base station associated with one USIM at a given time or simultaneously receiving from a base station associated with each USIM.

Referring to FIG. 1N, the multi-USIM capable UE 1n-01 may mean a UE that supports multiple USIMs in one device. For example, the multi-USIM capable UE may mean a USIM 1 UE 1n-02 in the case of operating in a USIM 1 and mean a USIM 2 UE 1n-03 in the case of operating in a USIM 2. The base station associated with each USIM may not recognize the MUSIM UE as one UE, but may recognize the MUSIM UE as one UE for each USIM UE. For example, a NW1 1n-04 may recognize a USIM 1 UE 1n-02 as one UE, and a NW2 1n-05 may recognize a USIM 2 UE 1n-03 as one UE. Hereinafter, in embodiments of the disclosure, for convenience of description, in the case that the MUSIM UE communicates using the USIM 1, the MUSIM UE is referred to as a USIM 1 UE, and in the case that the MUSIM UE communicates using the USIM 2, the MUSIM UE is referred to as a USIM 2 UE. For example, the MUSIM UE may be a USIM 1 UE or a USIM 2 UE according to which USIM between the USIM 1 and the USIM 2 is used.

In step 1n-10, the USIM 1 UE 1n-02 may configure an RRC connection with the NW1 1n-04 to be in an RRC connected mode (RRC_CONNECTED).

In step 1n-10, because the USIM 2 UE 1n-03 does not configure an RRC connection with the NW2 1n-05, the USIM 2 UE 1n-03 may be in an RRC idle mode (RRC_IDLE) or an RRC inactive mode (RRC_INACTIVE).

The disclosure may be equally applied even to the case that the USIM 2 UE 1n-03 configures an RRC connection with the NW2 1n-05 to be in an RRC connected mode (RRC_CONNECTED).

In step 1n-15, the USIM 1 UE 1n-02 may transmit a UE capability information message (UECapabilityInformation) to the NW1 1n-04. This may follow the foregoing embodiment. Additionally, the UE capability information message may include the following information.
1-bit indicator indicating whether the USIM 1 UE 1n-02 supports a MUSIM gap priority configuration and preference to the NW1 1n-04, and the indicator is a per UE capability indicator and may not distinguish between xDD/FDD (1 optional per-UE capability bit (without xDD/FRx differentation) to indicate MUSIM gap priority configuration and preference). The UE may support the capability indicator in the case that it supports the capability (musim-GapPreference) of the foregoing embodiment.
Indicator indicating to the NW1 1n-04 that the USIM 1 UE 1n-02 supports a keep solution (e.g., 1 optional per-UE capability bit to indicate the support of applying keep solution)
The keep solution means that all colliding MUSIM gaps are maintained, and the UE may apply all colliding MUSIM gaps.

For reference, an indicator that supports a keep solution may not be included separately. In this case, it may mean that the UE also supports a keep solution in the case that it supports a 1-bit indicator indicating whether it supports a MUSIM gap priority configuration and preference.

In step 1n-20, the NW1 1n-04 may transmit otherConfig to the USIM 1 UE 1n-02.

More specifically, the NW1 1n-04 may transmit a predetermined RRC message (e.g., an RRCReconfiguration message) including configuration information (musim-GapAssistanceConfig) that enables the USIM1 UE 1n-02 to report preferred/required MUSIM gap information for a MUSIM operation. Additionally, the musim-GapAssistanceConfig may be stored in otherConfig. This may follow the foregoing embodiment.

Additionally, according to an embodiment of the disclosure, the musim-GapAssistanceConfig may include at least one of the following information.
An indicator reporting a gap priority preferred by the UE (e.g., one bit to indicate whether the UE can report MUSIM gap priority preference)
The indicator may have the advantage of preventing the UE from reporting this when the base station does not understand the gap priority preferred by the UE.
An indicator reporting when the UE wants to maintain and use colliding MUSIM gaps without dropping them (e.g., one bit to indicate whether the UE wants to apply/use keep solution)

In step 1n-25, the USIM 2 UE 1n-03 may determine whether it should perform required activities in an RRC idle mode or an RRC inactive mode. This may follow the foregoing embodiment.

In step 1n-30, the USIM 2 UE 1n-03 may notify the USIM 1 UE 1n-02 of required information in order to perform an operation of step 1n-25 in an RRC idle mode or an RRC inactive mode. This may follow the foregoing embodiment.

In step 1n-35, the USIM 1 UE 1n-02 may determine whether to initiate transmission of UEAssistanceInformation to the NW1 1n-04.

More specifically, the USIM 1 UE 1n-02 according to the disclosure may distinguish the case that it is configured to provide only MUSIM assistance information for MUSIM gap preference and the case that while it is configured to provide MUSIM assistance information for MUSIM gap preference, it is configured to provide MUSIM assistance information for MUSIM gap priority preference to determine whether to transmit UEAssistanceInformation to the base station 1n-04. For example, in the case that it is configured to provide only MUSIM assistance information for gap preference, the USIM 1 UE 1n-02 may transmit UEAssistanceInformation including a musim-GapPreferenceList to the base station 1n-04 according to the foregoing embodiment (see FIG. 1F).
In the case that while it is configured to provide MUSIM assistance information for gap preference, it is simultaneously configured to provide MUSIM assistance information for MUSIM gap priority preference, when at least one of conditions proposed below is satisfied, the USIM 1 UE 1n-02 according to the disclosure may determine whether to transmit UEAssistanceInformation to the base station 1n-04. More specifically, in the case that one of the following conditions 1 to 5 is satisfied or in the case that a combination of the following conditions is satisfied, the USIM 1 UE 1n-02 may determine whether to transmit UEAssistanceInformation to the base station 1n-04.
Condition 1: In the case that the UE has a preference on the MUSIM gap(s) and that the UE did not transmit a UEAssistanceInformation message with musim-GapPreferenceList to the base station 1n-04 because it was configured to provide MUSIM assistance information for gap preference, the UE may initiate transmission of the current musim-GapPreferenceList and UEAssistanceInformation to provide the musim-GapPriorityPreferenceList. The UE may run or rerun the T346h timer according to a timer value configured in the musim-GapProhibitTimer. For reference, the musim-GapPriorityPreferenceList includes a GapPriority (represented as a natural number value from 1 to 16, wherein 1 represents the highest gap priority) for each periodic MUSIM gap included in the musim-GapPreferenceList. For example, in the case that the UE does not separately indicate a GapPriority for the aperiodic MUSIM gap (because the aperiodic MUSIM gap always has the highest priority gap priority) and that the musim-GapPreferenceList includes one or more periodic MUSIM gaps, the UE has a features of always including a GapPriority therefor in the musim-GapPriorityPreferenceList.
Condition 2: In the case that the UE has a preference on the MUSIM gap(s) priority and that the UE did not transmit a UEAssistanceInformation message with musim-GapPriorityPreferenceList to the base station 1n-04 because it was configured to provide MUSIM assistance information for gap priority preference and that the timer T346h is not running, the UE may initiate transmission of a current musim-GapPriorityPreferenceList and UEAssistanceInformation to provide the musim-GapPriorityPreferenceList. The UE may run or rerun the T346h timer according to a timer value configured in the musim-GapProhibitTimer. For example, in the case that the USIM 1 UE 1n-02 initiates transmission of UEAssistanceInformation in order to request an aperiodic MUSIM gap to the base station 1n-04 and runs or reruns the T346h timer according to a timer value configured in the musim-GapProhibitTimer, when the USIM 1 UE 1n-02 requests one or more periodic MUSIM gaps and MUSIM gap priority preferences therefor, or one or more periodic MUSIM gaps and MUSIM gap priority preferences therefor and a previously transmitted (or to be newly transmitted) aperiodic MUSIM gap to the base station 1n-04, if the timer T346h is running, the USIM 1 UE In-02 has a feature of not initiating transmission of UEAssistanceInformation therefor.
Condition 3: In the case that the current musim-GapPreferenceList is different from the one indicated in the last transmission of the UEAssistanceInformation message including musim-GapPreferenceList and that the timer T346h is not running, the UE may initiate transmission of the current musim-GapPreferenceList and UEAssistanceInformation to provide the musim-GapPriorityPreferenceList. The UE may run or rerun the T346h timer according to a timer value configured in the musim-GapProhibitTimer.
Condition 4: In the case that the current musim-GapPriorityPreferenceList is different from the one indicated in the last transmission of the UEAssistanceInformation message including musim-GapPriorityPreferenceList and that the timer T346h is not running, the UE may initiate transmission of the current musim-GapPreferenceList and UEAssistanceInformation to provide the musim-GapPriorityPreferenceList. The UE may run or rerun the T346h timer according to the timer value configured in a musim-GapProhibitTimer. For reference, the current musim-GapPreferenceList being different may correspond to the case that a value of musim-GapKeepPrefence is changed or different. It may be distinguished by a separate condition (i.e., the following condition 5).
Condition 5: In the case that the current musim-GapKeepPreference is different from the one indicated in the last transmission of the UEAssistanceInformation message including musim-GapKeepPreference and that the timer T346h is not running, the UE may initiate transmission of the current musim-GapPreferenceList and UEAssistanceInformation to provide the musim-GapPriorityPreferenceList. The UE may run or rerun the T346h timer according to a timer value configured in a musim-GapProhibitTimer. For reference, in the case that the UE previously sent a musim-GapKeepPreference to the base station, but that the base station does not allow the musim-GapKeepPreference (musim-GapKeep) and that there is no current musim-GapKeepPreference, the UE may not initiate transmission of a separate UEAssistanceInformation message (the UE may transmit a separate UEAssitanceInformation message because the T346h timer has expired).

The above conditions may be expressed as an example as follows.
1> if configured to provide MUSIM assistance information for gap preference:
   2> if configured to provide MUSIM assistance information for gap priority preference:
      3> if the UE has a preference on the MUSIM gap(s) and the UE did not transmit a UEAssistanceInformation message with musim-GapPreferenceList since it was configured to provide MUSIM assistance information for gap preference; or
      3> if the UE has a preference on the MUSIM gap(s) and the UE did not transmit a UEAssistanceInformation message with musim-GapPriorityPreferenceList since it was configured to provide MUSIM assistance information for gap priority preference and the timer T346h is not running; or
      3> if the current musim-GapPreferenceList is different from the one indicated in the last transmission of the UEAssistanceInformation message including musim-GapPreferenceList and the timer T346h is not running; or
      3> if the current musim-GapPriorityPreferenceList (and/or musim-GapKeepPreference) is different from the one indicated in the last transmission of the UEAssistanceInformation message including musim-GapPriorityPreferenceList (and/or musim-GapKeepPreference) and the timer T346h is not running:
         4> initiate transmission of the UEAssistanceInformation message in accordance with 5.7.4.3 to provide the current musim-GapPreferenceList and/or musim-GapPriorityPreferenceList and/or musim-GapKeepPreference;
         4>start or restart the timer T346h with the timer value set to the musim-GapProhibitTimer.
   2> else:
      3> if the UE has a preference on the MUSIM gap(s) and the UE did not transmit a UEAssistanceInformation message with musim-GapPreferenceList since it was configured to provide MUSIM assistance information for gap preference; or
      3> if the current musim-GapPreferenceList is different from the one indicated in the last transmission of the UEAssistanceInformation message including musim-GapPreferenceList and the timer T346h is not running:
         4> initiate transmission of the UEAssistanceInformation message in accordance with 5.7.4.3 to provide the current musim-GapPreferenceList;
         4> start or restart the timer T346h with the timer value set to the musim-GapProhibitTimer.

For example, the USIM 1 UE 1n-01 according to the disclosure has a feature of not initiating transmission of the current musim-GapPreferenceList and/or UEAssistanceInformation to provide the musim-GapPriorityPreferenceList and/or musim-GapKeepPreference in the case that a timer T346h is running. The UE has a feature that when it initiates transmission of the current musim-GapPreferenceList and/or UEAssistanceInformation to provide the musim-GapPriorityPreferenceList and/or musim-GapKeepPreference, it runs only once or reruns the timer T346h according to a timer value configured in a musim-GapProhibitTimer.

For reference, the USIM 1 UE 1n-02 may include the current musim-GapPreferenceList and/or musim-GapPriorityPreferenceList and/or musim-GapKeepPreference in the UEAssistanceInformation message according to the following procedure.
2> if the UE has a preference for MUSIM periodic gap(s):
   3> include musim-GapPreferenceList with an entry for each periodic gap the UE prefers to be configured;
      4> set musim-GapLength and musim-GapRepetitionAndOffset in the musim-GapInfo IE to the values of the length and the repetition/offset of the gap(s), respectively, the UE prefers to be configured with;
2> if the UE has a preference for MUSIM aperiodic gap:
   3> include the field musim-GapPreferenceList, with one entry for the aperiodic gap the UE prefers to be configured;
      4> include musim-GapLength in the musim-GapInfo IE and set it to the values of the length of the gap the UE prefers to be configured with;
      4>optionally include musim-Starting-SFN-AndSubframe in the musim-GapInfo IE and set it to the starting SFN/subframe of the gap the UE prefers to be configured with;
2> if the UE has no longer preference for the periodic/aperiodic gaps:
   3>do not include musim-GapPreferenceList in the musim-Assistance IE;
2> if UE has a preference for MUSIM gap priority:
   3> include the musim-GapPriorityPreferenceList the UE prefers to be configured;
   3> if the UE has preference to keep all collided MUSIM gaps:
      4> include the musim-GapKeep;
In step 1n-40, the NW1 1n-04 may transmit an RRCReconfiguration message including musim-GapConfig to the USIMM 1 UE 1n-02.

More specifically, the NW1 1n-04 may transmit a predetermined RRC message (e.g., RRCReconfiguration message) containing one or more MUSIM gap configuration information (musim-GapConfig) based on the musim-GapPreferenceList and/or musim-GapPriorityPreferenceList and/or musim-GapKeepPreference requested by the USIM 1 UE 1n-02 in response to step 1n-35. This may follow at least one of the foregoing embodiments.

In step 1n-45, the USIM 1 UE 1n-02 may transmit an RRCReconfigurationComplete message to the NW1 1n-04.

Methods according to the embodiments described in the claims or specifications of the disclosure may be implemented in the form of hardware, software, or a combination of hardware and software.

In the case of being implemented in software, a computer readable storage medium storing one or more programs (software modules) may be provided. One or more programs stored in the computer readable storage medium are configured for execution by one or more processors in an electronic device. The one or more programs include instructions for causing an electronic device to execute methods according to embodiments described in claims or specification of the disclosure.

Such programs (software modules, software) may be stored in random access memory, non-volatile memory including flash memory, read only memory (ROM), electrically erasable programmable ROM (EEPROM), magnetic disc storage device, compact disc-ROM (CD-ROM), digital versatile discs (DVDs), another form of optical storage device, or a magnetic cassette. Alternatively, the programs may be stored in memory including a combination of some or all thereof. Further, each constitution memory may be included in the plural.

Further, the program may be stored in an attachable storage device that may access through a communication network, such as the Internet, Intranet, local area network (LAN), wide LAN (WLAN), or storage area network (SAN), or a communication network including a combination thereof. Such a storage device may access a device implementing an embodiment of the disclosure through an external port. Further, a separate storage device on the communication network may access the device implementing the embodiment of the disclosure.

In an embodiment of the disclosure, the term “computer program product” or “computer readable medium” is used for collectively referring to media, such as memory, a hard disk installed in a hard disk drive, and signals. These “computer program products” or “computer readable medium” are components provided in a method of reporting UE capabilities in a wireless communication system according to the disclosure.

The machine readable storage medium may be provided in the form of a non-transitory storage medium. Here, ‘non-transitory storage medium’ is a tangible device and only means that the storage medium does not include a signal (e.g., electromagnetic wave), and this term does not distinguish the case that data is semi-permanently stored in the storage medium and the case that data is temporary stored. For example, a ‘non-transitory storage medium’ may include a buffer in which data is temporarily stored.

According to an embodiment or the disclosure, a method according to various embodiments disclosed in this document may be included and provided in a computer program product. Computer program products may be traded between sellers and buyers as commodities. The computer program product may be distributed in the form of a machine readable storage medium (e.g., compact disc read only memory (CD-ROM)), or via an application store (e.g., Play Store™) or may be distributed (e.g., download or upload) online or directly between two user devices (e.g., smartphones). In the case of online distribution, at least a part of the computer program product (e.g., downloadable app) may be at least temporarily stored or temporarily generated in a machine readable storage medium, such as memory of a server of a manufacturer, a server of an application store, or a relay server.

In the specific embodiments of the disclosure described above, components included in the disclosure are expressed in the singular or plural according to the presented specific embodiments. However, the singular or plural expression is appropriately selected for a situation presented for convenience of description, and the disclosure is not limited to the singular or plural components, and even if a component is represented in the plural, it may include the singular, or even if a component is represented in the singular, it may include the plural.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, a radio resource control (RRC) message for configuring the UE to provide a preference for a multi-universal subscriber identity module (MUSIM) gap and a MUSIM gap priority;
identifying whether to initiate a transmission of a UE assistance information message for providing first preference information on the MUSIM gap priority or second preference information indicating to keep all colliding MUSIM gaps based on a timer T346h; and
in case that the timer T346h is not running, initiating the transmission of the UE assistance information message for providing the first preference information or the second preference information.

2. The method of claim 1, wherein the UE initiates the transmission of the UE assistance information message to provide the first preference information or the second preference information, in case that the UE has a preference on the MUSIM gap and the UE did not transmit the UE assistance information message with the first preference information, and the timer T346h is not running.

3. The method of claim 1, wherein the UE initiates the transmission of the UE assistance information message to provide the first preference information or the second preference information, in case that current first preference information or second preference information is different from the one indicated in a last transmission of the UE assistance information message and the timer T346h is not running.

4. The method of claim 1, further comprising:
starting the timer T346h.

5. The method of claim 4,
wherein the timer T346h is a prohibit timer associated with reporting the preference on the MUSIM gap, and
wherein the timer T346h starts upon transmitting the UE assistance information message with at least one the first preference information, the second preference information, or third preference information on the MUSIM gap and a related MUSIM gap configuration.

6. The method of claim 1, further comprising:
in case that the UE has a preference for the MUSIM gap priority, including the first preference information in the UE assistance information message;
identifying whether the UE has a preference to keep all colliding MUSIM gaps; and
in case that the UE has the preference to keep all colliding MUSIM gaps, including the second preference information in the UE assistance information message.

7. A method performed by a base station in a wireless communication system, the method comprising:
transmitting, to a user equipment (UE), a radio resource control (RRC) message for configuring the UE to provide a preference for a multi-universal subscriber identity module (MUSIM) gap and a MUSIM gap priority; and
receiving, from the UE, a UE assistance information message including at least one first preference information on the MUSIM gap priority or second preference information indicating to keep all colliding MUSIM gaps,
wherein the UE assistance information message including the at least one first preference information or second preference information is received in case that a timer T346h is not running.

8. The method of claim 7, wherein the base station receives the UE assistance information message including the at least one first preference information or the second preference information, in case that the UE has a preference on the MUSIM gap and the base did not receive the UE assistance information message with the first preference information, and the timer T346h is not running.

9. The method of claim 7, wherein the base station receives the UE assistance information message including the first preference information or the second preference information, in case that current first preference information or second preference information is different from the one indicated in a last reception of the UE assistance information message and the timer T346h is not running.

10. The method of claim 7,
wherein the timer T346h is a prohibit timer associated with reporting the preference on the MUSIM gap, and
wherein the timer T346h starts upon transmitting the UE assistance information message with at least one the first preference information, the second preference information, or third preference information on the MUSIM gap and a related MUSIM gap configuration.

11. The method of claim 7, wherein the second preference information is included in the UE assistance information message in case that the first preference information is included in the UE assistance information message.

12. A user equipment (UE) in a wireless communication system, the UE comprising:
a transceiver; and
a controller coupled with the transceiver and configured to:
receive, from a base station, a radio resource control (RRC) message for configuring the UE to provide a preference for a multi-universal subscriber identity module (MUSIM) gap and a MUSIM gap priority,
identify whether to initiate a transmission of a UE assistance information message for providing first preference information on the MUSIM gap priority or second preference information indicating to keep all colliding MUSIM gaps based on a timer T346h, and
in case that the timer T346h is not running, initiate the transmission of the UE assistance information message for providing the first preference information or the second preference information.

13. The UE of claim 12, wherein the UE initiates the transmission of the UE assistance information message to provide the first preference information or the second preference information, in case that the UE has a preference on the MUSIM gap and the UE did not transmit the UE assistance information message with the first preference information, and the timer T346h is not running.

14. The UE of claim 12, wherein the UE initiates the transmission of the UE assistance information message to provide the first preference information or the second preference information, in case that current first preference information or second preference information is different from the one indicated in a last transmission of the UE assistance information message and the timer T346h is not running.

15. The UE of claim 12, wherein the controller is further configured to:
start the timer T346h,
wherein the timer T346h is a prohibit timer associated with reporting the preference on the MUSIM gap, and
wherein the timer T346h starts upon transmitting the UE assistance information message with at least one the first preference information, the second preference information, or third preference information on the MUSIM gap and a related MUSIM gap configuration.

16. The UE of claim 12, wherein the controller is further configured to:
in case that the UE has a preference for the MUSIM gap priority, include the first preference information in the UE assistance information message,
identify whether the UE has a preference to keep all colliding MUSIM gaps, and
in case that the UE has the preference to keep all colliding MUSIM gaps, include the second preference information in the UE assistance information message.

17. A base station in a wireless communication system, the base station comprising:
a transceiver; and
a controller coupling with the transceiver and configured to:
transmit, to a user equipment (UE), a radio resource control (RRC) message for configuring the UE to provide a preference for a multi-universal subscriber identity module (MUSIM) gap and a MUSIM gap priority, and
receive, from the UE, a UE assistance information message including at least one first preference information on the MUSIM gap priority or second preference information indicating to keep all colliding MUSIM gaps,
wherein the UE assistance information message including the at least one first preference information or second preference information is received in case that a timer T346h is not running.

18. The base station of claim 17, wherein the base station receives the UE assistance information message including the at least one first preference information or the second preference information, in case that the UE has a preference on the MUSIM gap and the base did not receive the UE assistance information message with the first preference information, and the timer T346h is not running.

19. The base station of claim 17, wherein the base station receives the UE assistance information message including the first preference information or the second preference information, in case that current first preference information or second preference information is different from the one indicated in a last reception of the UE assistance information message and the timer T346h is not running.

20. The base station of claim 19,
wherein the timer T346h is a prohibit timer associated with reporting the preference on the MUSIM gap,
wherein the timer T346h starts upon transmitting the UE assistance information message with at least one the first preference information, the second preference information, or third preference information on the MUSIM gap and a related MUSIM gap configuration, and
wherein the second preference information is included in the UE assistance information message in case that the first preference information is included in the UE assistance information message.
